(19) United States
(12) Patent Application Publication
(10) Pub. No.: US 2012/0169270 A1
(43) Pub. Date: Jul. 5, 2012

(54) BATTERY PACK APPARATUS INCLUDING A MULTI-CHANNEL 4-TERMINAL NETWORK CHARGING APPARATUS AND A MULTI-CHANNEL BATTERY POWER SUPPLY MODULE

(76) Inventors: Jae-myung Cho, Seoul (KR); Sol Han, Seoul (KR); Mi-hwa Kweon, Seoul (KR); Yung-min Cho, Seoul (KR); Hae-min Cho, Seoul (KR); Young-ha Oh, Seoul (KR)

(21) Appl. No.: 13/395,083

(22) PCT Filed: Nov. 10, 2009
(86) PCT No.: PCT/KR09/06563

§ 371 Date: Mar. 8, 2012

(30) Foreign Application Priority Data
Sep. 16, 2009 (KR) 10-2009-0087599

(51) Int. Cl. H02J 7/04; H02J 7/00

(52) U.S. Cl. 320/101; 320/162

(57) ABSTRACT

The disclosure is to provide a battery pack apparatus including in one form a multi-channel network charging apparatus and a multi-channel battery power supply module. A battery pack apparatus using sunlight and commercial electricity, and comprising a solar cell panel, a charging apparatus, a monitoring unit, and a battery power supply module, can perform quick charging using a multi-channel network method when charging a charging battery of a multi-channel battery power supply module with electricity generated from collected sunlight and commercial electricity, enables easy replacement of a charging battery as charging batteries of the multi-channel battery power supply module are mounted in a configuration enabling the independent respective detachment thereof, wherein one network control board is inserted in each of the four charging batteries in order to control the four charging batteries and to detect the input voltages, input currents, output voltages, and output currents thereof.

### RELATED APPLICATIONS

This application claims priority benefit of PCT application PCT/KR2009/006563 filed Nov. 10, 2009 claiming priority of 10-2009-0087599(KR), filed Sep. 16, 2009, incorporated herein by reference.

### BACKGROUND OF THE DISCLOSURE

a) Field of the Disclosure

This disclosure relates to a battery pack apparatus comprised in one form of a multi-channel 4-terminal network charging module and a multi-channel battery power-supply module, wherein, when solar energy is collected and electricity is charged in a battery, the battery pack apparatus detects a voltage of a multi-channel battery power-supply input terminal (DC input terminal), performs detection and operation processing by a 4-terminal network, and is quickly charged.

b) Description of the Related Art

As a countermeasure to environmental problems, most companies or developers are conducting intensive research into a hybrid vehicle that is driven by power generated by at least one of an engine and a motor.

The hybrid vehicle includes a high-voltage battery for traveling such that power is provided to the motor.

The power charged in this traveling battery may also be used to start an engine.

For example, the hybrid vehicle provides power to a motor generator connected to an engine, drives the motor generator as a motor, and thus starts the engine.

The hybrid vehicle includes a low-voltage battery for auxiliary devices, such that the low-voltage battery can provide power to either an auxiliary device for travel control or other auxiliary devices mounted to a vehicle.

Compared to a system driven only by an engine, the auxiliary battery of the hybrid vehicle is operated not only as a power source for auxiliary devices, but also as a control power source of a high-voltage system including the battery for vehicle traveling, such that the importance of the auxiliary battery of the hybrid vehicle is rapidly increasing in proportion to the increasing load.

A conventional hybrid vehicle includes a converter circuit that converts electric energy of a high-voltage system into a low voltage and charges an auxiliary device battery with electricity, such that electric energy can be provided to the auxiliary device battery. Representative examples of the conventional hybrid vehicle have been disclosed in Japanese Patent Laid-open Publication No. 2003-70103, Japanese Patent Laid-open Publication No. 2003-189401, and Japanese Patent Laid-open Publication No. 2003-320807.

However, in the case where an auxiliary device battery for use in the hybrid vehicle is charged with not only electricity generated by solar energy, but also a commercial power source, it is difficult for the auxiliary device battery to be rapidly charged with electricity, such that a charging time is unavoidably increased, resulting in the occurrence of a large amount of power leakage.

Also, in the case where the hybrid vehicle is charged with electricity at home, an electric line connected to the auxiliary device battery is provided to each home, such that a user must manually charge each battery with electricity for 6 to 12 hours, resulting in greater inconvenience of use.

### SUMMARY

Therefore, this disclosure has been made in view of the above problems, and it is an object of the disclosure to provide a battery pack apparatus including a multi-channel 4-terminal network charging module and a multi-channel battery power-supply module. When solar energy is collected and electricity or a commercial power source is provided to a battery, the battery pack apparatus controls the multi-channel 4-terminal network charging module to be quickly charged according to a multi-channel 4-terminal network scheme, a battery of the multi-channel battery power-supply module in one form is independently configured in the form of a detachable structure, and one 4-terminal network control board for detecting an input voltage, an input current, an output voltage, and an output current by controlling for example four batteries is inserted at intervals of four batteries, such that the batteries can be easily replaced with others, and a battery status of the multi-channel battery power-supply module can be checked in real time through a monitoring unit connected via RS232, resulting in increased charging efficiency of a multi-channel battery power-supply module.

For ease in understanding, a multi-channel (n-channel), multi-terminal (k-terminal) apparatus will be described by a specific example where n=32 and k=4 although other configurations are conceived.

The above and other objects can be accomplished in one form by the provision of a battery pack apparatus which uses electricity generated from a solar panel and a commercial power source (for example 18V˜50V) and includes a multi-channel 4-terminal network charging module and a 32-channel battery power-supply module, the apparatus including a main frame which may be configured as a rectangular box; a 32-channel 4-terminal charging unit which is formed in the main frame, is connected to positive (+) and negative (−) connection terminals of a charging battery of a 32-channel battery power-supply module, reads an input voltage, an input current, an output voltage, and an output current of the charging battery, performs detection and operation processing by a 4-terminal network, and charges a 32-channel battery power-supply unit using a 32-channel 4-terminal network scheme; and a 32-channel battery power-supply unit including 32 charging battery cell structures, in which an input voltage detection terminal and an input current detection terminal of the 32-channel 4-terminal charging unit are connected to a positive (+) terminal of each charging battery, and an output voltage detection terminal and an output current detection terminal of the 32-channel 4-terminal charging unit are connected to a negative (−) terminal of each charging battery, such that the 32-channel battery power-supply unit is quickly charged through the 32-channel 4-terminal network charging unit.

### BRIEF DESCRIPTION OF THE DRAWINGS

The above and other objects, features and other advantages will be more clearly understood from the following detailed description taken in conjunction with the accompanying drawings, in which:

FIG. 1 is a configuration view illustrating one embodiment of a structure in which a battery pack apparatus comprised of a 32-channel 4-terminal charging module and a 32-channel battery power-supply module is connected to a monitoring unit and a solar panel.

FIG. 2 is a block diagram illustrating one embodiment of constituent elements of a battery pack apparatus comprised of a 32-channel 4-terminal charging module and a 32-channel battery power-supply module.

FIG. 3 is a block diagram illustrating one embodiment of constituent elements of a 32-channel 4-terminal charging module.

FIG. 4 is a block diagram illustrating one embodiment of constituent elements of a 4-terminal network control board.

FIG. 5 is a block diagram illustrating one embodiment of constituent elements of a 32-channel battery power-supply module.

FIG. 6 is a perspective view illustrating one embodiment of a battery pack apparatus comprised of a 32-channel 4-terminal charging module and a 32-channel battery power-supply module.

FIG. 7 is an exploded perspective view illustrating one embodiment of a battery pack apparatus comprised of a 32-channel 4-terminal charging module and a 32-channel battery power-supply module.

FIG. 8 is a perspective view illustrating one embodiment of a structure in which one 4-terminal network control board is inserted at intervals of four batteries contained in a 32-channel battery power-supply module, such that the 4-terminal network control board detects an input voltage, an input current, an output current, and an output voltage by directly controlling four batteries.

FIG. 9 is a circuit diagram illustrating one embodiment of a circuit in which a microprocessor is connected to peripheral devices.

FIG. 10 is a circuit diagram illustrating one embodiment of a circuit in which a charging battery unit comprised of 32 battery cell structures is connected to a connector for connection to the charging battery unit.

FIG. 11 is a circuit diagram illustrating one embodiment of a circuit in which a board ID setup unit and a first analog-to-digital (AD) converter from among constituent elements of a 4-terminal network control board are connected to each other.

FIG. 12 is a circuit diagram illustrating one embodiment of a circuit in which a board identifier (ID) setup unit and a first AD converter from among constituent elements of a 4-terminal network control board are connected to each other.

FIG. 13 is a circuit diagram illustrating one embodiment of a circuit in which a board ID setup unit and a first AD converter from among constituent elements of a 4-terminal network control board are connected to each other.

FIG. 14 is a circuit diagram illustrating one embodiment of a circuit in which a board ID setup unit and a first AD converter from among constituent elements of a 4-terminal network control board are connected to each other.

FIG. 15 is a circuit diagram illustrating one embodiment of a power control unit.

FIG. 16 is a basic circuit diagram illustrating one embodiment of a 4-terminal network.

### DETAILED DESCRIPTION

Several embodiments will be described in detail with reference to the drawings. In the drawings, the same or similar elements are denoted by the same reference numerals even though they are depicted in different drawings. In the following description, a detailed description of known functions and configurations incorporated herein will be omitted when it may make the subject matter unclear.

In one form or the battery pack apparatus comprised of a multi-channel 4-terminal network charging module and a multi-channel battery power-supply module, one 4-terminal network control board for detecting an input voltage, an input current, an output current and an output voltage by directly controlling four batteries is inserted at intervals of four batteries, such that a user can easily replace an old battery with a new one from anywhere he or she wishes at any time.

In one form of the battery pack apparatus, a specific ID is assigned to a plurality of 4-terminal network control boards, such that a user can easily recognize locations and replacement times of 32 batteries through a monitoring unit at a desired place, for example, the interior of a vehicle or at a remote site. So, even if the user is located at a remote site from the battery pack apparatus, the user can manage the locations and replacement times of 32 batteries using a wireless communication technology.

In addition, when a conventional battery pack apparatus is charged with electricity through a battery input terminal, if it is assumed that 32 batteries are charged one by one, an overall charging time of the 32 batteries is excessively increased. The battery pack apparatus in one embodiment includes a multi-channel 4-terminal network charging module and a multi-channel battery power-supply module, such that it can simultaneously charge a plurality of batteries (i.e., first to n-th batteries) through a multi-channel 4-terminal network charging module, and can simultaneously charge for example 16 batteries, 32 batteries, 64 batteries, and/or 128 batteries through the extension of ports.

The multi-channel battery power-supply module in one embodiment is applicable to a hybrid device for vehicles, such that it can quickly charge vehicles with electricity.

The battery pack apparatus 100 in one embodiment includes a 32-channel battery power-supply module and a 32-channel 4-terminal charging module. The 32-channel battery power-supply module includes a charging battery unit including a plurality of batteries. The plurality of batteries may include a 1st battery, a 2nd battery, a 3rd battery, a 4th battery, a 5th battery, a 6th battery, a 7th battery, an 8th battery, a 9th battery, a 10th battery, an 11th battery, a 12th battery, a 13th battery, a 14th battery, a 15th battery, a 16th battery, a 17th battery, an 18th battery, a 19th battery, a 20th battery, a 21st battery, a 22nd battery, a 23rd battery, a 24th battery, a 25th battery, a 26th battery, a 27th battery, a 28th battery, a 29th battery, a 30th battery, a 31st battery, and a 32nd battery.

In another embodiment, through the reduction or extension of ports, the battery pack apparatus may be comprised of a 16-channel 4-terminal network charging module and a 16-channel battery power-supply module. Alternatively, the battery pack apparatus may be comprised of an 8-channel 4-terminal network charging module and an 8-channel battery power-supply module.

The 1st battery to be charged may be any one of a 1st battery 131-1, a 5th battery 131-5, a 9th battery 131-9, a 13th battery 131-13 and the like each of which corresponds to one battery having an address ‘00’ from among four batteries configuring one group of batteries.

The 2nd battery to be charged may be any one of a 2nd battery 131-2, a 6th battery 131-6, a 10th battery 131-10, a 14th battery 131-14 and the like, each of which corresponds to one battery having an address ‘01’ from among four batteries configuring one group of batteries.

The 3^{rd} battery to be charged may be any one of a 3rd battery 131-3, a 7th battery 131-7, an 11th battery 131-11, a 15th battery 131-15 and the like, each of which corresponds to one battery having an address ‘10’ from among four batteries configuring one group of batteries.

The 4th battery to be charged may be any one of a 4th battery 131-4, a 7th battery 131-8, an 11th battery 131-12, a 15th battery 131-16 and the like, each of which corresponds to one battery having an address ‘11’ from among four batteries configuring one group of batteries.

Next, a battery pack apparatus comprised of a 32-channel 4-terminal charging module and a 32-channel battery power-supply module will hereinafter be described in detail.

Embodiments will hereinafter be described with reference to the annexed drawings.

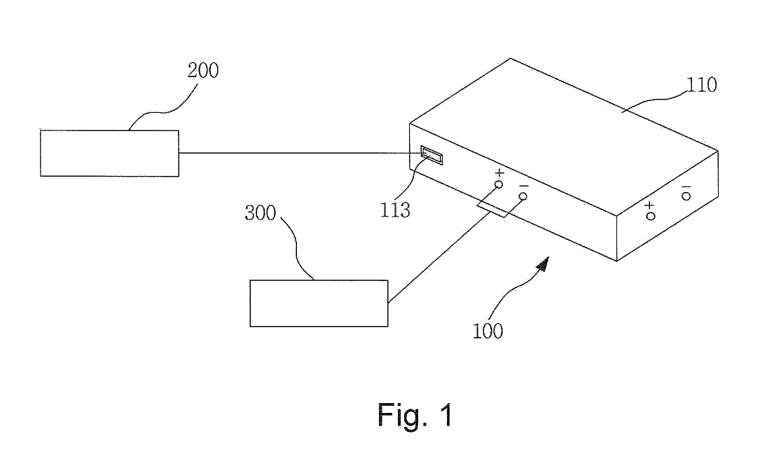

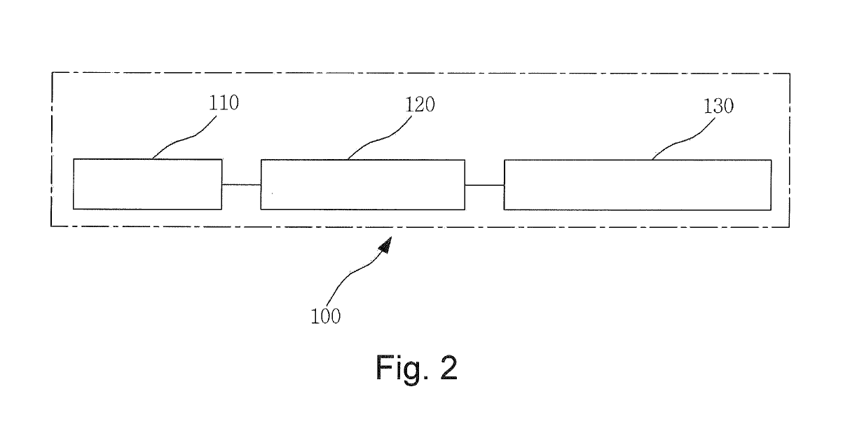

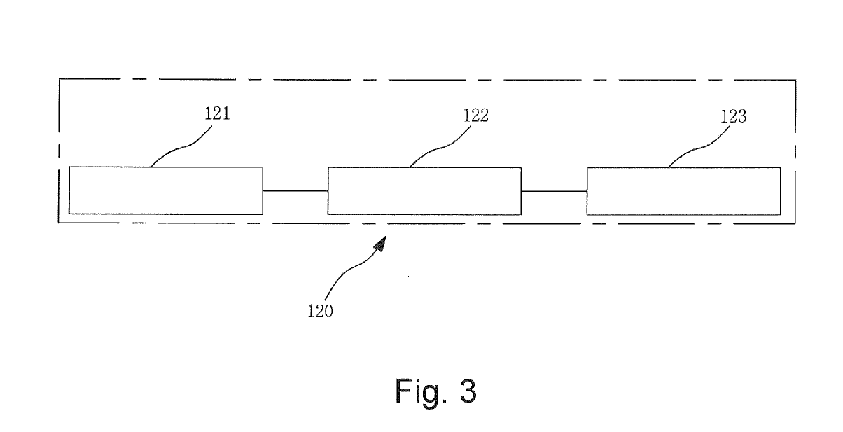

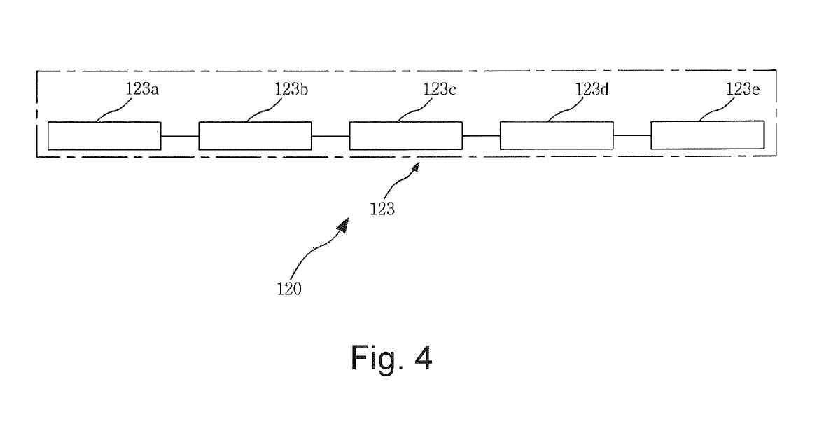

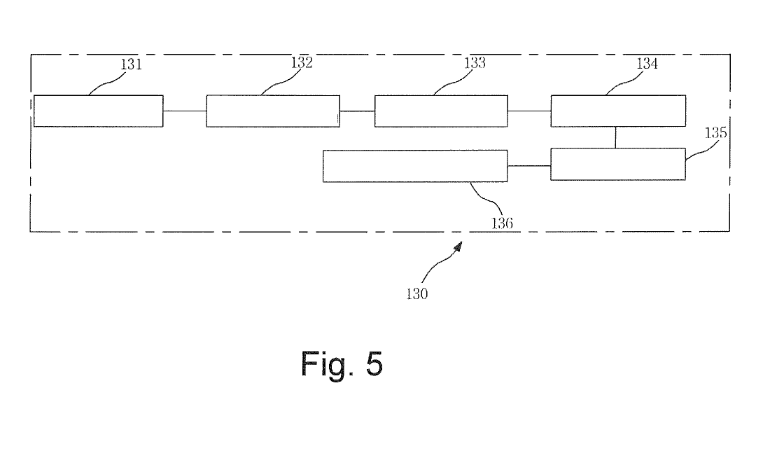

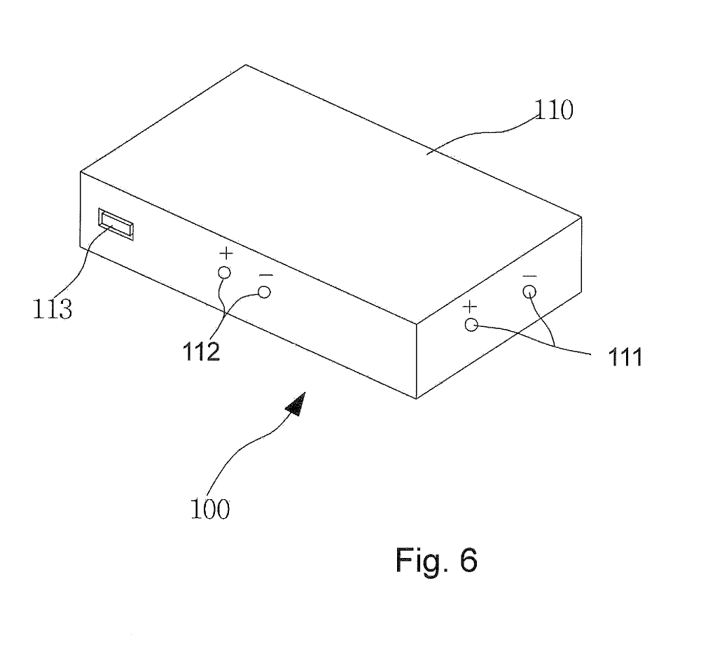

FIG. 1 is a perspective view illustrating one embodiment of a structure in which a battery pack apparatus 100 comprised of a 32-channel 4-terminal charging module and a 32-channel battery power-supply module is connected to a monitoring unit 200 and a solar panel 300. FIG. 2 is a block diagram illustrating constituent elements of a battery pack apparatus comprised of a 32-channel 4-terminal charging module and a 32-channel battery power-supply module. FIG. 3 is a block diagram illustrating constituent elements of a 32-channel 4-terminal charging module. FIG. 4 is a block diagram illustrating constituent elements of one form of a 4-terminal network control board. FIG. 5 is a block diagram illustrating constituent elements of a 32-channel battery power-supply module. FIG. 6 is a perspective view illustrating a battery pack apparatus 100 comprised of a 32-channel 4-terminal charging module and a 32-channel battery power-supply module in one form.

Referring to FIG. 6, the battery pack apparatus 100 in one form is comprised of a 32-channel 4-terminal charging module and a 32-channel battery power-supply module includes a main frame 110 that may be configured in the form of a rectangular box. The battery pack apparatus 100 includes a first connection terminal 111 installed at one side of the main frame 110, and a second connection terminal 112 installed at the other side of the main frame 110. The first connection terminal 111 is used as a connection terminal for connection to an external device, such as for example a motor and a generator of a hybrid vehicle. The second connection terminal 112 may be used as a power-supply connection terminal for applying the electricity generated from a solar panel or a commercial power source (18V˜50V) to the main frame 110.

In one embodiment, An RS-232 cable port and a Universal Serial Bus (USB) port 113 are installed at the other side of the main frame 110. These ports may be connected to a notebook computer, or a desktop computer, each of which has a monitoring function.

The 32-channel 4-terminal charging module 120 in one form is located at the bottom of the main frame 110, and includes a power control unit 121 and a microprocessor 122 that are contained in a first Printed Circuit Board (PCB) 120a.

In one embodiment, both ends of the first PCB 120a are brought into contact with the interior surface of the main frame 110 with a bolt, such that the rear end of the first PCB 120a faces upward and is arranged in a horizontal direction.

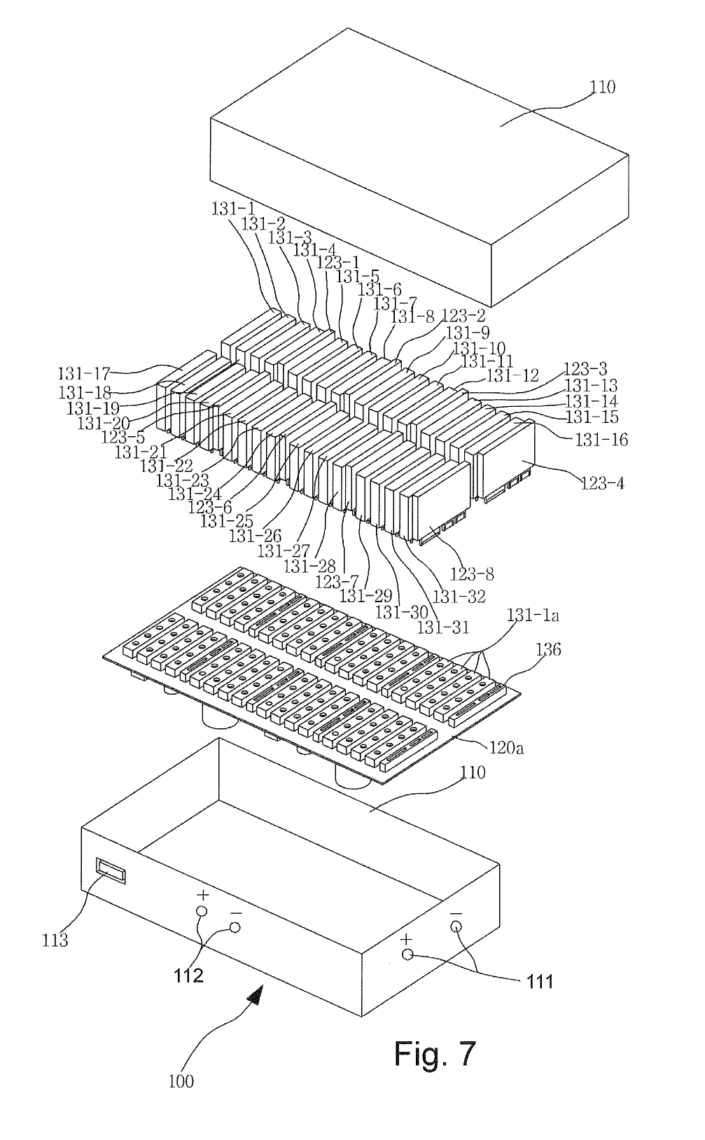

Referring to FIG. 7, a first connector 131-1a for connection to the charging battery unit and a second connector 136 for connection to the 4-terminal network control board may be arranged at the rear end of the first PCB 120a. If necessary, a plurality of first connectors 131-1a may be used, and a plurality of second connectors 136 may be used.

In one embodiment, one second connector 136 is installed at intervals of four first connectors 131-1a, such that it allows the 4-terminal network control board 123 to directly control four batteries at intervals of four battery units so as to detect an input voltage, an input current, an output voltage, and an output current of each group of four batteries.

A charging battery unit acting as a constituent element of the 32-channel battery power-supply module may be detachably connected to the first connector that is located at the first PCB so as to connect to the charging battery unit.

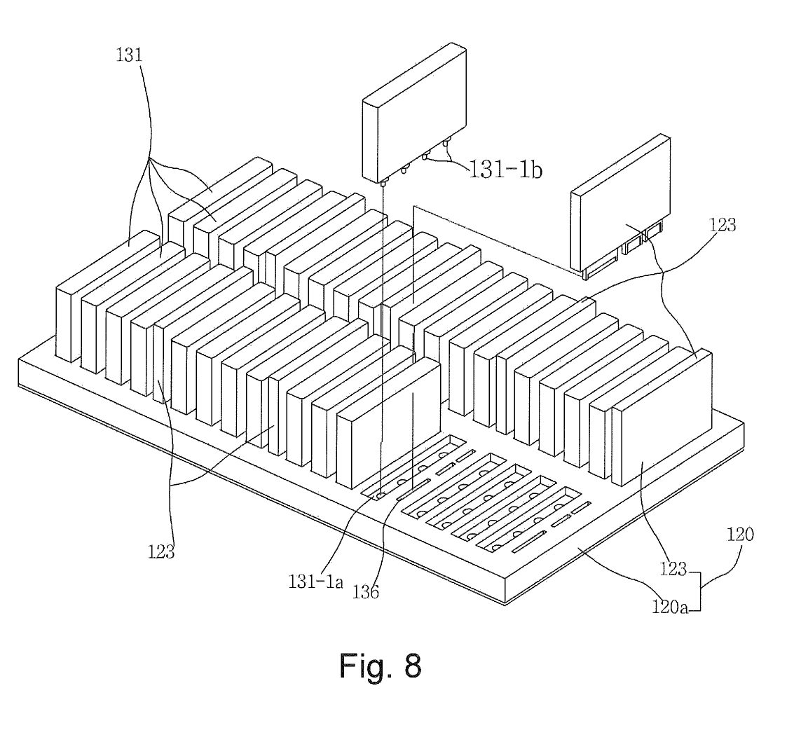

Referring to FIG. 8, the charging battery unit is shown as configured in the form of a slim rectangular box, and a 4-pin type connection pin is configured in a projected format so that the charging battery unit can be detachably connected to a connector for connection to the 4-pin type charging battery unit.

One embodiment of a 32-channel 4-terminal charging module 120 from among constituent elements of the battery pack apparatus 100 will hereinafter be described with reference to the drawings.

The 32-channel 4-terminal charging module 120 may be formed in the main frame 110 configured in the form of a rectangular box, which may be connected to positive (+) and negative (−) connection parts (i.e., positive (+) and negative (−) connection sockets) of the 32-channel battery power-supply module, reads an input voltage, an input current, an output voltage, and an output current of the charging battery, performs detection and operation processing by a 4-terminal network, and charges the 32-channel battery power-supply module using the 32-channel 4-terminal network scheme. Referring to FIG. 3, the 32-channel 4-terminal charging module 120 in one form includes a power control unit 121, a microprocessor 122, and a 4-terminal network control board 123.

In this case, the power control unit 121 and the microprocessor 122 are mounted to one first PCB, and are installed at the bottom of the main frame 110.

The 4-terminal network control board 123 in one embodiment is configured in the form of a pin-insertion type PCB. A 50-pin type connection pin is formed at one side of the 4-terminal network control board 123, and is inserted into the connector for connection to the 4-terminal network control board. The 50-pin type connection pin is detachably connected to the 4-terminal network control board connector.

The power control unit 121 performs a power control function so as to convert the electricity generated from a solar panel and a commercial power source (18V˜50V) according to capacity of the charging battery unit, and provides the reduced electricity and commercial power source.

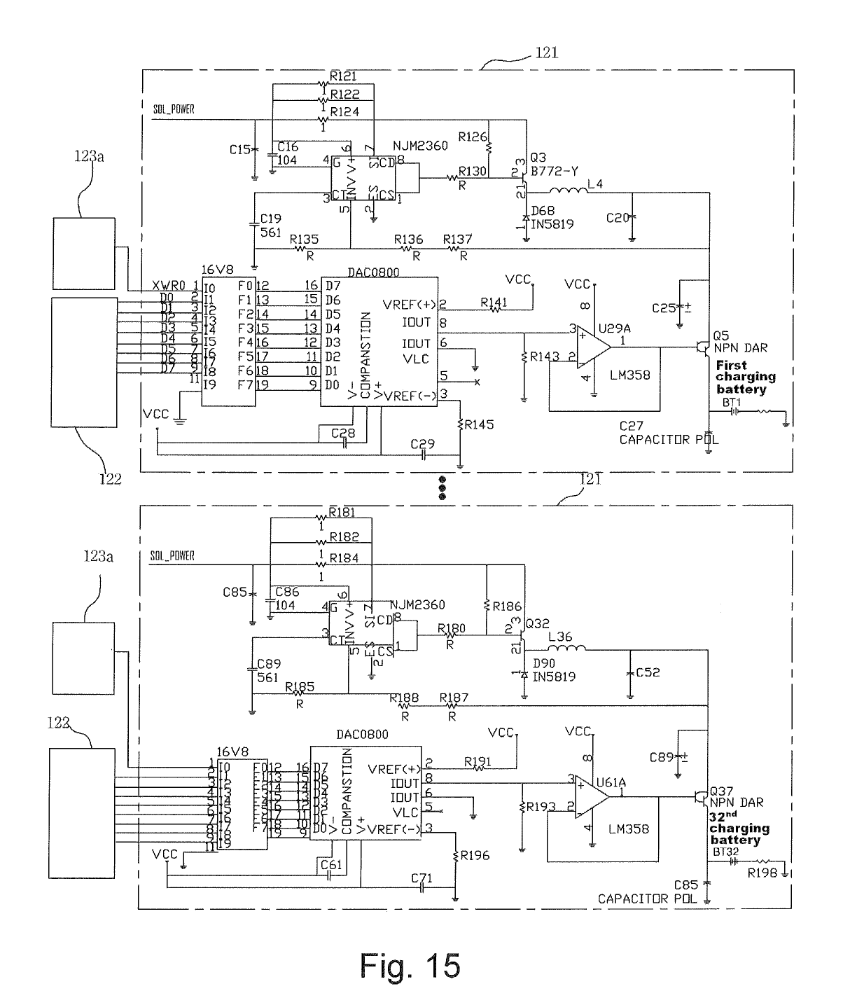

FIG. 15 is a circuit diagram illustrating a power control unit in one form. The power control unit 121 includes a DC/DC converter, a buffer unit, a first Digital-to-Analog Converter (DAC), an amplifier, and a transistor. In one example the transistor is an NPN Darlington (DAR) transistor.

The DC/DC converter in one form has a step-down converter function. In one embodiment, the DC/DC converter performs the step-down converter function in such a manner that the electricity (SOL_POWER) generated from the solar panel or the commercial power source (16V˜50V) exceeds the capacity of the charging battery unit by a predetermined voltage of 1V.

In one embodiment, the power control unit 121 may convert the electricity generated from the solar panel or the commercial power source to exceed the capacity of the charging battery unit by a predetermined voltage of 1V through resistors R135, R136 and R137, such that it applies the resultant electricity or commercial power source to a specific terminal (INV) of the DC/DC converter. The electricity generated from the solar panel or the commercial source (18V˜50V) is voltage-division processed through resistors R121, R122 and R124, and the voltage-division result is applied to a terminal (V+) of the DC/DC converter and a current peak sense terminal (SI). A comparator compares a first voltage applied to a comparison inverting input terminal (INV) of the DC/DC converter with an internal reference voltage of 1.25V. If the first voltage is higher than the reference voltage, a drive collector terminal (CD) is driven so that a transistor Q3 is turned on through a sensing resistor R130.

In one configuration, the transistor Q3 is turned on, a voltage-divided resultant voltage (SOL_POWER) stored in a collector terminal of the transistor Q3 and the commercial power source (16V˜50V) pass through an emitter terminal, are smoothed through a diode D68, and are finally output through an inductor L4.

In this case, a voltage (POW1) of 5.2V may be output through the inductor L4, such that the voltage of 5.2V is applied to a collector terminal of the DAR transistor Q5 and therefore a standby mode is provided.

If the microprocessor transmits an 8-bit digital signal indicating a current charging voltage status of a first battery to the buffer unit, the buffer unit transmits the received signal to the first DAC, and the first DAC compares a current charging voltage with a reference voltage of 4.2V. If the current charging voltage is equal to or less than the reference voltage of 4.2V, a turn-ON driving current signal of the DAR transistor Q5 flows into a positive (+) terminal of the amplifier connected to an output terminal (IOUT).

If the turn-ON driving current signal of the DAR transistor Q5 is applied, a charging voltage (5.2V) stored in the collector terminal of the DAR transistor Q5 passes through the emitter terminal, and is charged in the first charging battery.

In the same manner, as shown in FIG. 15, according to a control signal of the microprocessor, the electrical signal (SOL_POWER) generated from the solar panel and the commercial power source (18V˜50V) are charged through the power control unit in each of a 2nd charging battery, a 3rd charging battery, a 4th charging battery, a 5th charging battery, a 4th charging battery, a 5th charging battery, a 6th charging battery, a 7th charging battery, an 8th charging battery, a 9th charging battery, a 10th charging battery, an 11th charging battery, a 12th charging battery, a 13th charging battery, a 14th charging battery, a 15th charging battery, a 16th charging battery, a 17th charging battery, an 18th charging battery, a 19th charging battery, a 20th charging battery, a 21st charging battery, a 22nd charging battery, a 23rd charging battery, a 24th charging battery, a 25th charging battery, a 26th charging battery, a 27th charging battery, a 28th charging battery, a 29th charging battery, a 30th charging battery, a 31st charging battery, and a 32nd charging battery.

Likewise, the DC/DC converter in one form performs power control in such a manner that the generated electricity or the commercial power source exceeds the capacity of the charging battery unit by a predetermined voltage of 1V, and enters a standby mode through a collector terminal of the DAR transistor. The microprocessor compares a current charging voltage of the charging battery unit with a reference voltage of 4.2V. The microprocessor generates a turn-ON driving current of the DAR transistor only when the current charging voltage is equal to or less than a reference voltage of 4.2V, such that it charges the charging battery. As a result, the microprocessor can effectively prevent the charging battery from becoming hot.

The microprocessor 122 in one configuration receives a power signal controlled by the power control unit, transmits a wake-up driving signal to each device, reads an input voltage, an input current, an output voltage, an output current of each charging battery unit through a 4-terminal network control board, and thus performs detection and operation processing using a 4-terminal network. The microprocessor 122 performs sampling at a specific timing point where the 32-channel battery power-supply module is charged with electricity according to the 32-channel 4-terminal network scheme. The microprocessor 122 controls the 32-channel battery power-supply module to be sequentially charged through 32 channels, and controls the monitoring unit to display a status of the charging battery unit and a status of the 32-channel power-supply module.

The microprocessor 122 may be comprised of an 89C52 8-bit microprocessor.

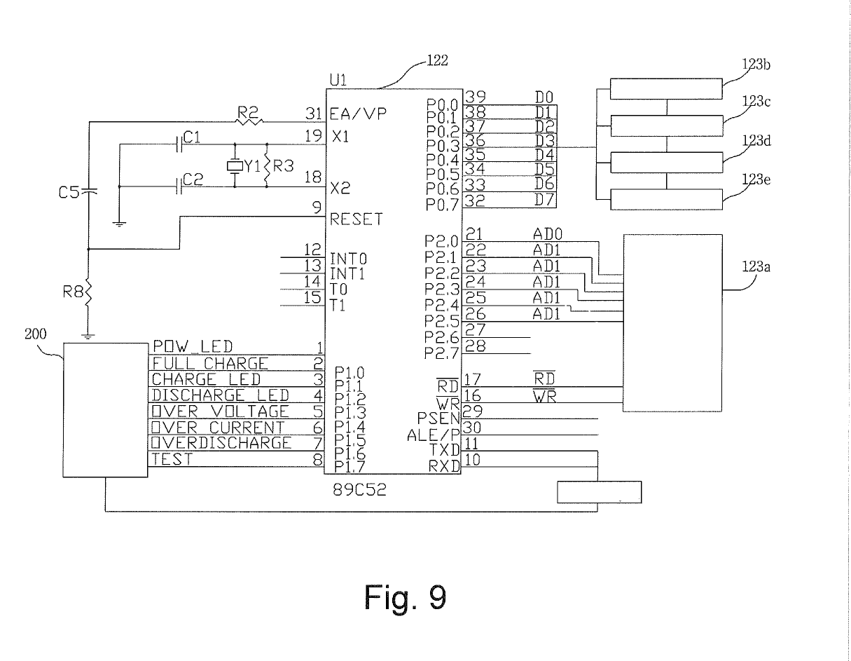

FIG. 9 is a circuit diagram illustrating one embodiment of a circuit in which a microprocessor 122 is connected to peripheral devices. Referring to FIG. 9, the monitoring unit is connected to input/output (I/O) ports (P1.0˜P1.7) through an RS-232 cable. Therefore, a connection signal (POW_LED) for connecting a charging battery to a multi-channel battery, a full charge signal (FULL_CHARGE) of the charging battery, a charge input signal (CHARGE_LED) of the charging battery through the power control unit, a discharge signal (DISCHARGE_LED) of the charging battery, an overvoltage signal (OVER_VOLTAGE) of the charging battery, an overcurrent signal (OVER_CURRENT) of the charging battery, an overdischarge signal (OVER_DISCHARGE) of the charging battery, and a test input signal (TEST) of the charging battery are output to the monitoring unit. The I/O ports (P0.0˜P0.7) are set to 8-bit digital signal input terminals, respectively. The I/O ports (P0.0˜P0.7) are connected to a first Analog to Digital Converter (ADC 123b), a second ADC 123c, a third ADC 123d, and a fourth ADC 123e. The 8-bit digital signal related to an input voltage, an input current, an output voltage, and an output current of the charging battery are input to each of the first to fourth ADCs 123b to 123e. The board ID setup unit 123a is connected to the I/O ports (P2.0˜P2.5) so as to control a plurality of charging batteries (i.e., four charging batteries) contained in one group to be selected by a read command signal (RD) and a write command signal (WR). In this case, one group comprised of four charging batteries belongs to the 4-terminal network control board corresponding to an ID that is established according to 6-bit address values of AD0, AD1, AD2, AD3, AD4 and AD5.

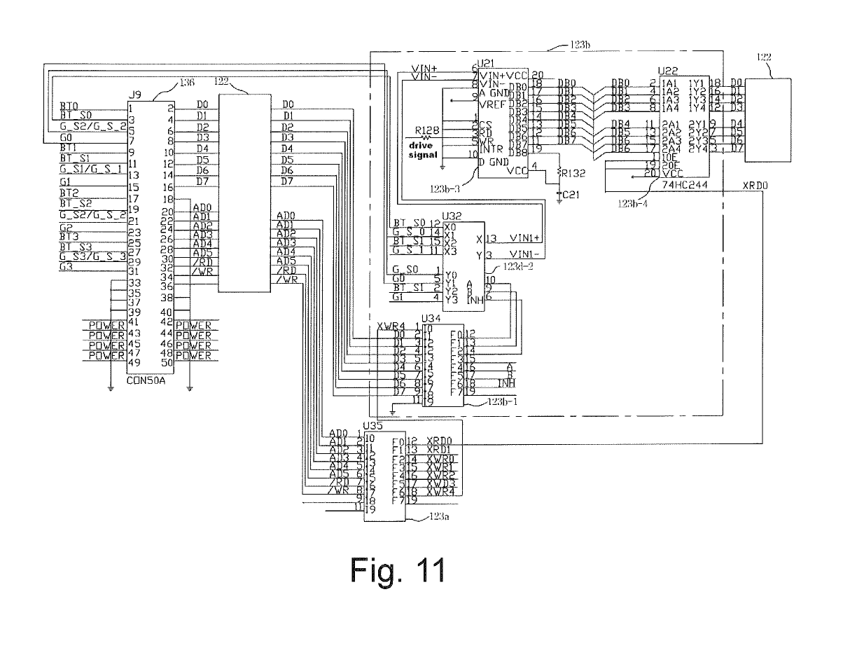

In other words, as shown in FIGS. 11 to 14, if the microprocessor enables the read command signal terminal (RD), four charging batteries of one group belonging to the 4-terminal network control board corresponding to an established ID are selected according to 6-bit address values of AD0, AD1, AD2, AD3, AD4 and AD5. Terminals D0, D1, D2, D3, D4, D5, D6 and D7 of each of the first ADC 123b, the second ADC 123c, the third ADC 123d, and the fourth ADC 123e are connected to the I/O ports (P0.0˜P0.7), respectively, such that the 8-bit digital signal related to an input voltage, an input current, an output voltage, and an output current of each of four charging batteries belonging to one group matched with the 4-terminal network control board is input to each ADC.

Referring to FIG. 15, if the microprocessor 122 enables the write command signal (WR), four charging batteries of one group belonging to the 4-terminal network control board corresponding to an established ID are selected according to 6-bit address values of AD0, AD1, AD2, AD3, AD4 and AD5. A charging battery selection signal for selecting a charging battery to be charged is applied to an input terminal of the buffer unit, and an 8-bit digital signal indicating a current charging voltage status of the charging battery is also applied to the input terminal of the buffer unit belonging to the power control unit, such that the desired battery can be charged with electricity.

The RS-232 cable in one form is connected to a transmission terminal (TXD) 206 and a reception terminal (RXD) 208 of the microprocessor so as to be connected to a notebook or external computer capable of performing a monitoring function.

In other words, a variety of signals are applied to the notebook or external computer having a monitoring function through the transmission terminal (TXD). For example, a connection signal (POW_LED) for connecting a charging battery to a multi-channel battery, a full charge signal (FULL_CHARGE) of the charging battery, a charge input signal (CHARGE_LED) of the charging battery through the power control unit, a discharge signal (DISCHARGE_LED) of the charging battery, an overvoltage signal (OVER_VOLTAGE) of the charging battery, an overcurrent signal (OVER_CURRENT) of the charging battery, an overdischarge signal (OVER_DISCHARGE) of the charging battery, and a test input signal (TEST) of the charging battery are applied to the notebook or external computer having the monitoring function through the transmission terminal (TXD).

In addition, the microprocessor may receive a base voltage of the charging battery unit comprised of a lithium (Li)-ion battery (4.2V) or a lead storage battery (13.8V) from the notebook or external computer having the monitoring function through the reception terminal (RXD), and perform the setup of the base voltage of the charging battery unit. Otherwise, the microprocessor may extend ports, and change the number of channels, such that 16 batteries or 64 batteries can be simultaneously charged.

The 4-terminal network control board 123 is detachably inserted into the charging battery units, each of which includes four batteries, from among the 32-channel battery power-supply module, and is connected to the positive (+) and negative (−) terminals of each charging battery unit. The 4-terminal network control board 123 reads an input voltage, an input current, an output voltage, and an output current of the charging battery unit, converts an analog signal into a digital signal. The 8-bit digital signal related to the input voltage, the input current, the output voltage, and the output current of the charging battery unit are applied to the microprocessor. One 4-terminal network control board for detecting the input voltage, the input current, the output voltage, and the output current by directly controlling four charging batteries may be inserted at intervals of four charging batteries.

FIG. 7 is an exploded perspective view illustrating one form of a battery pack apparatus comprised of a 32-channel 4-terminal charging module and a 32-channel battery power-supply module. Referring to FIG. 7, the 4-terminal network control board 123 includes a first 4-terminal network control board 123-1, a second 4-terminal network control board 123-2, a third 4-terminal network control board 123-3, a fourth 4-terminal network control board 123-4, a fifth 4-terminal network control board 123-5, a sixth 4-terminal network control board 123-6, a seventh 4-terminal network control board 123-7, and an eighth 4-terminal network control board 123-8. In more detail, the first 4-terminal network control board 123-1 directly controls a first-group charging battery unit comprised of a first charging battery 131-1, a second charging battery 131-2, a third charging battery 131-3, and a fourth charging battery 131-4 so as to detect an input voltage, an input current, an output voltage, and an output current of the first-group charging battery unit. The second 4-terminal network control board 123-2 directly controls a second-group charging battery unit comprised of a fifth charging battery 131-5, a sixth charging battery 131-6, a seventh charging battery 131-7, and an eighth charging battery 131-8 so as to detect an input voltage, an input current, an output voltage, and an output current of the second-group charging battery unit. The third 4-terminal network control board 123-3 directly controls a third-group charging battery unit comprised of a ninth charging battery 131-9, a 10th charging battery 131-10, an 11th charging battery 131-11, and a 12th charging battery 131-12 so as to detect an input voltage, an input current, an output voltage, and an output current of the third-group charging battery unit. The fourth 4-terminal network control board 123-4 directly controls a fourth-group charging battery unit comprised of a 13th charging battery 131-13, a 14th charging battery 131-14, a 15th charging battery 131-15, and a 16th charging battery 131-16 so as to detect an input voltage, an input current, an output voltage, and an output current of the fourth-group charging battery unit. The fifth 4-terminal network control board 123-5 directly controls a fifth-group charging battery unit comprised of a 17th charging battery 131-17, an 18th charging battery 131-18, a 19th charging battery 131-19, and a 20th charging battery 131-20 so as to detect an input voltage, an input current, an output voltage, and an output current of the fifth-group charging battery unit. The sixth 4-terminal network control board 123-6 directly controls a sixth-group charging battery unit comprised of a 21st charging battery 131-21, a 22nd charging battery 131-22, a 23rd charging battery 131-23, and a 24th charging battery 131-24 so as to detect an input voltage, an input current, an output voltage, and an output current of the sixth-group charging battery unit. The seventh 4-terminal network control board 123-7 directly controls a seventh-group charging battery unit comprised of a 25th charging battery 131-25, a 26th charging battery 131-26, a 27th charging battery 131-27, and a 28th charging battery 131-28 so as to detect an input voltage, an input current, an output voltage, and an output current of the seventh-group charging battery unit. The eighth 4-terminal network control board 123-8 directly controls an eighth-group charging battery unit comprised of a 29th charging battery 131-29, a 30th charging battery 131-30, a 31st charging battery 131-31, and a 32nd charging battery 131-32 so as to detect an input voltage, an input current, an output voltage, and an output current of the eighth-group charging battery unit.

Referring to FIG. 4, the 4-terminal network control board 123 in one form includes a board ID setup unit 123a, a first ADC 123b, a second ADC 123c, a third ADC 123d, and a fourth ADC 123e.

The board ID setup unit 123a in one form is connected to an address setup terminal of the microprocessor 122, establishes a specific board ID in the 4-terminal network control board in such a manner that the microprocessor can select a desired charging battery unit according to an established address value. Thereafter, the board ID setup unit 123a may control each group charging battery unit comprised of four charging batteries matched with the 4-terminal network control board corresponding to a specific board ID to be selected according to a read command signal (RD) and a write command signal (WD) of the microprocessor. As shown in FIGS. 11 to 14, the board ID setup unit 123a may be comprised of a 16V8 buffer 123b-4, 123c-4, 123d-4 or 123e-4.

In one embodiment, the 6-bit address setup terminals (AD0, AD1, AD2, AD3, AD4 and AD5) of the microprocessor, the read command signal terminal (RD), and the read command signal terminal (WD) are connected to the input terminals I0˜I7 of the board ID setup unit 123a. The 8-bit digital input signal, that is converted through the ADC and relates to an output voltage and an output current of the first charging battery, is applied to an output terminal F0 of the board ID setup unit 123a. The other 8-bit digital input signal, that is converted through the ADC and relates to an input voltage, an input current, an output voltage, and an output current of the second charging battery, is applied to an output terminal F1 of the board ID setup unit 123a.

The first to fourth battery selection units (123b-1, 123c-1, 123d-1, and 123e-1) may be respectively connected to a first ADC 123b, a second ADC 123C, a third ADC 123d, and a fourth ADC 123e are connected to the output terminal F6 of the board ID setup unit 123a. By the 4-bit operation of the output terminals (F2, F3, F4 and F5), the 4-terminal network control board corresponding to a specific board ID is selected by a signal of 4 bits.

If a specific board ID is set to ‘000’ by the 4-bit operation of the output terminals (F2, F3, F4 and F5), the first 4-terminal network control board 123-1 is selected. If a specific board ID is set to ‘001’ by the 4-bit operation of the output terminals (F2, F3, F4 and F5), the second 4-terminal network control board 123-2 is selected. If a specific board ID is set to ‘010’ by the 4-bit operation of the output terminals (F2, F3, F4 and F5), the third 4-terminal network control board 123-3 is selected. If a specific board ID is set to ‘011’ by the 4-bit operation of the output terminals (F2, F3, F4 and F5), the fourth 4-terminal network control board 123-4 is selected. If a specific board ID is set to ‘100’ by the 4-bit operation of the output terminals (F2, F3, F4 and F5), the fifth 4-terminal network control board 123-5 is selected. If a specific board ID is set to ‘101’ by the 4-bit operation of the output terminals (F2, F3, F4 and F5), the sixth 4-terminal network control board 123-6 is selected. If a specific board ID is set to ‘110’ by the 4-bit operation of the output terminals (F2, F3, F4 and F5), the seventh 4-terminal network control board 123-7 is selected. If a specific board ID is set to ‘111’ by the 4-bit operation of the output terminals (F2, F3, F4 and F5), the eighth 4-terminal network control board 123-8 is selected.

A detailed description of the selection of the charging battery unit in response to the address value established in the microprocessor will hereinafter be described with reference to the annexed drawings.

If the address value established in the microprocessor is ‘00000’, the first charging battery is selected. If the address value established in the microprocessor is ‘00001’, the second charging battery is selected. If the address value established in the microprocessor is ‘00010’, the third charging battery is selected. If the address value established in the microprocessor is ‘00011’, the fourth charging battery is selected. If the address value established in the microprocessor is ‘00110’, the fifth charging battery is selected. If the address value established in the microprocessor is ‘00111’, the sixth charging battery is selected. If the address value established in the microprocessor is ‘01000’, the seventh charging battery is selected. If the address value established in the microprocessor is ‘01001’, the eighth charging battery is selected. If the address value established in the microprocessor is ‘01010’, the ninth charging battery is selected. If the address value established in the microprocessor is ‘01011’, the 10th charging battery is selected. If the address value established in the microprocessor is ‘01100’, the 11th charging battery is selected.

In the case of using the first ADC 123b, in order for the charging battery unit to be selected according to the address value established in the microprocessor, if the 4-terminal network control board corresponding to a specific board ID of the 4-terminal network control board is selected, a first charging battery corresponding to an address ‘00’ from among four charging batteries belonging to one group matched with the 4-terminal network control board is selected by a signal of 2 bits, and the first ADC 123b is connected to positive (+) and negative (−) terminals of the first charging battery, and converts an analog signal related to an input voltage, an input current, an output voltage, and an output current of the first charging battery into a digital signal so as to transmit an 8-bit digital signal related to an input voltage, an input current, an output voltage, and an output current of the first charging battery to the microprocessor.

FIG. 11 is a circuit diagram illustrating one embodiment of a circuit in which a board ID setup unit and a first ADC from among constituent elements of the 4-terminal network control board are connected to each other. Referring to FIG. 11, the first ADC 123b may include a first battery selection unit 123b-1, a first analog multiplexer 123b-2, a first ADC Integrated Chip (IC) 123b-3, and a first non-inverting buffer 123b-4.

In the case of using the first battery selection unit 123b-1, in order for the charging battery unit to be selected according to the address value established in the microprocessor, if the 4-terminal network control board corresponding to a specific board ID of the 4-terminal network control board is selected, a first charging battery corresponding to an address ‘00’ from among four charging batteries belonging to one group matched with the 4-terminal network control board is selected by a signal of 2 bits.

In one embodiment, described in more detail, an output terminal F6 of the board ID setup unit 123a is connected to the input terminal 10, such that the 4-terminal network control board corresponding to a specific board ID is selected as a signal of 4 bits by the 4-bit operation. I/O ports (P0.0˜P0.7) of the microprocessor are connected to input terminals (I1˜I8), respectively, such that the 8-bit digital signal related to an input voltage, an input current, an output voltage, and an output current of the first charging battery from among four charging batteries belonging to one group matched with the 4-terminal network control board is input to the input terminals (I1˜I8).

A channel terminal A of a 2-channel analog multiplexer 123b-2 in one embodiment is connected to an output terminal F0, and a channel terminal B of a first analog multiplexer is connected to an output terminal F1, such that a first charging battery corresponding to the address ‘00’ is selected through the 2-bit operation.

The first analog multiplexer 123b-2 is connected to an input voltage detection terminal, an input current detection terminal, an output voltage detection terminal, and an output current detection terminal of the first charging battery. A specific analog signal related to an input voltage, an input current, an output voltage, and an output current from among several analog signals transmitted from the first charging battery is selected by the first analog multiplexer 123b-2, such that the detected signal is transmitted to the first ADC IC through two channels.

For example, the first analog multiplexer may detect an analog signal related to an output voltage and an output current, and transmits the detected signal to the first ADC through 2 channels. A detailed operation of the first analog multiplexer in one form will hereinafter be described.

If the output terminal F0 of the first battery selection unit is connected to the channel terminal A, the output terminal F1 of the first battery selection unit is connected to the channel terminal B, and a first charging battery corresponding to the address ‘00’ is selected through the 2-bit operation, an output voltage that is loaded at positive (+) and negative (−) terminals of the first charging battery is applied to input terminals X0 and Y0 of the first analog multiplexer 123b-2, such that the first analog multiplexer 123b-2 transmits the received voltage signal to a terminal (VIN+) of the ADC IC through an output terminal (X), and transmits the received voltage signal to a terminal (VIN−) of the ADC IC through the output terminal (Y). An output current loaded at both terminals equal to the positive (+) and negative (−) terminals of the first charging battery is applied to the input terminals X1 and Y1, such that the output current is transmitted to a terminal (VIN+) of the ADC IC through the output terminal (X) and is transmitted to a terminal (VIN−) of the ADC IC through the output terminal (Y).

The first ADC IC 123b-3 in one embodiment receives an analog signal related to an output voltage and an output current of the first charging battery from the first analog multiplexer, converts an analog signal related to the output voltage and the output current of the first charging battery into an 8-bit digital signal, and transmits the 8-bit digital signal to the buffer unit.

In one form, an output terminal (X) of the first analog multiplexer is connected to the terminal (VIN+) of the first ADC IC, and an output terminal (Y) of the first analog multiplexer is connected to a terminal (VIN−) of the first ADC IC. If the analog signal related to the output voltage and the output current of the first charging battery is input to the first ADC IC 123b-3, the first ADC IC 123b-3 converts the received analog signal into an 8-bit digital signal through terminals DB0˜DB7, such that the 8-bit digital signal is applied to the input terminal of the buffer unit.

The non-inverting buffer unit 123b-4 performs non-inverting of the 8-bit digital signal, that is transmitted from the first ADC IC and relates to an output voltage and an output current of the first charging battery, so that the non-inverting result is output to the I/O ports (P0.0˜P0.7) of the microprocessor.

Through terminals 10E and 20E of the non-inverting buffer unit, the 8-bit digital input signal (XRD0) may be related to an output voltage and an output current of the first charging battery is applied to an output terminal F0 of the board ID setup unit 123a.

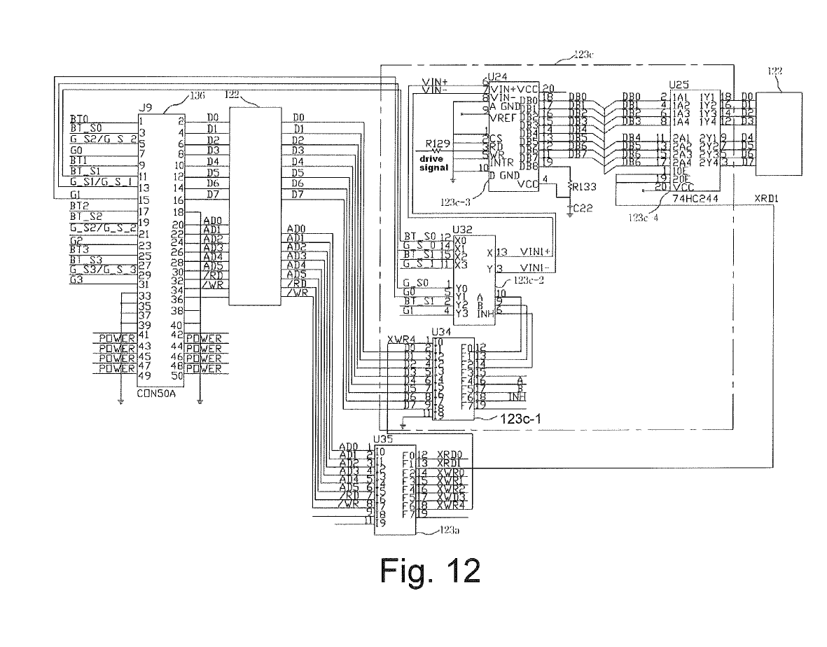

FIG. 12 is a circuit diagram illustrating one embodiment of a circuit in which a board ID setup unit and a first ADC from among constituent elements of the 4-terminal network control board are connected to each other. Referring to FIG. 12, if the 4-terminal network control board corresponding to a specific board ID is selected by an address setup signal of the microprocessor, the second ADC 123c controls a second charging battery corresponding to an address ‘01’ from among four charging batteries contained in one group matched with the 4-terminal network control board to be selected by a signal of 2 bits, is connected to positive (+) and negative (−) terminals of the second charging battery, and converts an analog signal related to an input voltage, an input current, an output voltage, and an output current of the second charging battery into a digital signal so as to transmit an 8-bit digital signal related to an input voltage, an input current, an output voltage, and an output current of the second charging battery to the microprocessor.

Referring still to FIG. 12, the second ADC 123c may include a second battery selection unit 123c-1, a second analog multiplexer 123c-2, a second ADC IC 123c-3, and a second non-inverting buffer 123c-4.

In the case of using the second battery selection unit 123c-1, in order for the charging battery unit to be selected according to the address value established in the microprocessor, if the 4-terminal network control board corresponding to a specific board ID of the 4-terminal network control board is selected, a second charging battery corresponding to an address ‘01’ from among four charging batteries belonging to one group matched with the 4-terminal network control board is selected by a signal of 2 bits.

In more detail, an output terminal F6 of the board ID setup unit 123a is connected to the input terminal 10, such that the 4-terminal network control board corresponding to a specific board ID is selected as a signal of 4 bits by the 4-bit operation. I/O ports (P0.0˜P0.7) of the microprocessor are connected to input terminals (I1˜18), respectively, such that the 8-bit digital signal related to an input voltage, an input current, an output voltage, and an output current of the first charging battery from among four charging batteries belonging to one group matched with the 4-terminal network control board is input to the input terminals (I1˜I8).

A channel terminal A of a 2-channel analog multiplexer in one configuration is connected to an output terminal F0, and a channel terminal B of a first analog multiplexer is connected to an output terminal F1, such that a second charging battery corresponding to the address ‘01’ is selected through the 2-bit operation.

The second analog multiplexer 123c-2 in one configuration is connected to an input voltage detection terminal, an input current detection terminal, an output voltage detection terminal, and an output current detection terminal of the second charging battery. A specific analog signal related to an input voltage, an input current, an output voltage, and an output current from among several analog signals transmitted from the second charging battery is selected by the second analog multiplexer 123c-2, such that the detected signal is transmitted to the second ADC IC through two channels.

For example, the second analog multiplexer may detect an analog signal related to an output voltage and an output current, and transmits the detected signal to the second ADC through 2 channels. A detailed operation of the second analog multiplexer will hereinafter be described.

In one embodiment, if the output terminal F0 of the second battery selection unit is connected to the channel terminal A, the output terminal F1 of the second battery selection unit is connected to the channel terminal B, and a second charging battery corresponding to the address ‘01’ is selected through the 2-bit operation, an output voltage that is loaded at positive (+) and negative (−) terminals of the second charging battery is applied to input terminals X0 and Y0 of the second analog multiplexer 123c-2, such that the second analog multiplexer 123c-2 transmits the received voltage signal to a terminal (VIN+) of the ADC IC through an output terminal (X), and transmits the received voltage signal to a terminal (VIN−) of the second ADC IC through the output terminal (Y).

The second ADC IC 123c-3 receives an analog signal related to an output voltage and an output current of the second charging battery from the second analog multiplexer, converts an analog signal related to the output voltage and the output current of the second charging battery into an 8-bit digital signal, and transmits the 8-bit digital signal to the second non-inverting buffer unit.

In more detail, an output terminal (X) of the second analog multiplexer is connected to the terminal (VIN+) of the second ADC IC, and an output terminal (Y) of the second analog multiplexer is connected to a terminal (VIN−) of the second ADC IC. If the analog signal related to the output voltage and the output current of the second charging battery is input to the second ADC IC, the second ADC IC converts the received analog signal into an 8-bit digital signal through terminals DB0˜DB7, such that the 8-bit digital signal is applied to the input terminal of the buffer unit.

The second non-inverting buffer unit 123c-4 in one form performs non-inverting of the 8-bit digital signal, that is transmitted from the second ADC IC and relates to an output voltage and an output current of the second charging battery, so that the non-inverting result is output to the I/O ports (P0.0˜P0.7) of the microprocessor.

Through terminals 10E and 20E of the second non-inverting buffer unit, the 8-bit digital input signal (XRD0) related to an output voltage and an output current of the second charging battery is applied to an output terminal F1 of the board ID setup unit 123a.

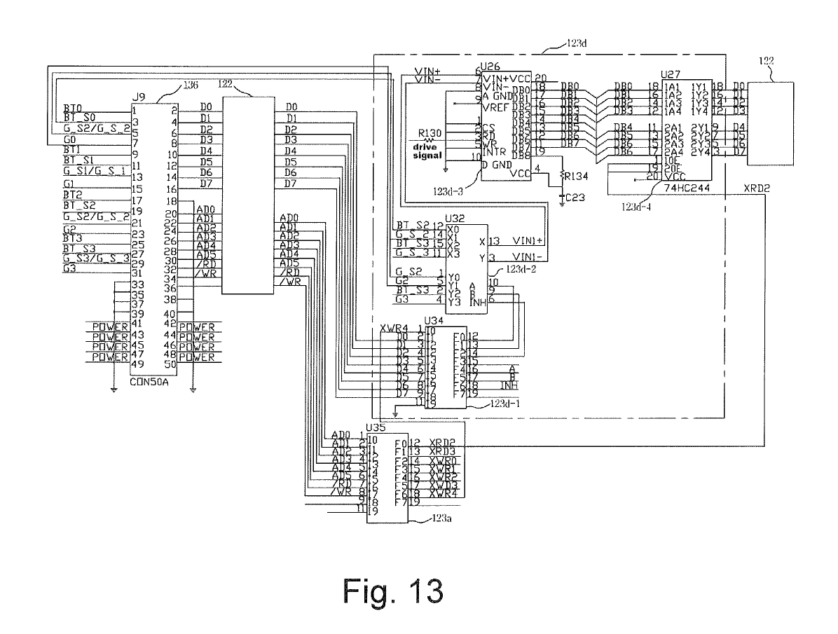

FIG. 13 is a circuit diagram illustrating a circuit in which a board ID setup unit and a first ADC from among constituent elements of the 4-terminal network control board are connected to each other. Referring still to FIG. 13, if the 4-terminal network control board corresponding to a specific board ID is selected by an address setup signal of the microprocessor, the third ADC 123d controls a third charging battery corresponding to an address ‘10’ from among four charging batteries contained in one group matched with the 4-terminal network control board to be selected by a signal of 2 bits, is connected to positive (+) and negative (−) terminals of the third charging battery, and converts an analog signal related to an input voltage, an input current, an output voltage, and an output current of the third charging battery into a digital signal so as to transmit an 8-bit digital signal related to an input voltage, an input current, an output voltage, and an output current of the third charging battery to the microprocessor.

Referring still to FIG. 13, the third ADC 123d may include a third battery selection unit 123d-1, a third analog multiplexer 123d-2, a third ADC IC 123d-3, and a third non-inverting buffer 123d-4.

In the case of using the third battery selection unit 123d-1, in order for the charging battery unit to be selected according to the address value established in the microprocessor, if the 4-terminal network control board corresponding to a specific board ID of the 4-terminal network control board is selected, a third charging battery corresponding to an address ‘10’ from among four charging batteries belonging to one group matched with the 4-terminal network control board is selected by a signal of 2 bits.

In one embodiment, an output terminal F6 of the board ID setup unit 123a is connected to the input terminal 10, such that the 4-terminal network control board corresponding to a specific board ID is selected as a signal of 4 bits by the 4-bit operation. I/O ports (P0.0˜P0.7) of the microprocessor are connected to input terminals (I1˜I8), respectively, such that the 8-bit digital signal related to an input voltage, an input current, an output voltage, and an output current of the third charging battery from among four charging batteries belonging to one group matched with the 4-terminal network control board is input to the input terminals (I1˜I8).

A channel terminal A of the third analog multiplexer is connected to an output terminal F0, and a channel terminal B of a third analog multiplexer is connected to an output terminal F1, such that a third charging battery corresponding to the address ‘10’ is selected through the 2-bit operation.

The third analog multiplexer 123d-2 is connected to an input voltage detection terminal, an input current detection terminal, an output voltage detection terminal, and an output current detection terminal of the third charging battery. A specific analog signal related to an input voltage, an input current, an output voltage, and an output current from among several analog signals transmitted from the third charging battery is selected by the third analog multiplexer 123d-2, such that the detected signal is transmitted to the third ADC IC through two channels.

For example, the third analog multiplexer 123d-2 may detect an analog signal related to an output voltage and an output current, and transmits the detected signal to the third ADC through 2 channels. Operation of the third analog multiplexer 123d-2 will hereinafter be described in detail.

If the output terminal F0 of the third battery selection unit is connected to the channel terminal A, the output terminal F1 of the third battery selection unit is connected to the channel terminal B, and a third charging battery corresponding to the address ‘01’ is selected through the 2-bit operation, an output voltage that is loaded at positive (+) and negative (−) terminals of the third charging battery is applied to input terminals X0 and Y0 of the third analog multiplexer 123d-2, such that the third analog multiplexer 123c-2 transmits the received voltage signal to a terminal (VIN+) of the ADC IC through an output terminal (X), and transmits the received voltage signal to a terminal (VIN−) of the third ADC IC through the output terminal (Y). An output current loaded at both terminals equal to the positive (+) and negative (−) terminals of the third charging battery is applied to the input terminals X1 and Y1, such that the output current is transmitted to a terminal (VIN+) of the third ADC IC through the output terminal (X) and is transmitted to a terminal (VIN−) of the third ADC IC through the output terminal (Y).

The third ADC IC 123d-3 in one form receives an analog signal related to an output voltage and an output current of the third charging battery from the third analog multiplexer, converts an analog signal related to the output voltage and the output current of the third charging battery into an 8-bit digital signal, and transmits the 8-bit digital signal to the third non-inverting buffer unit.

In one embodiment, an output terminal (X) of the third analog multiplexer is connected to the terminal (VIN+) of the third ADC IC, and an output terminal (Y) of the third analog multiplexer is connected to a terminal (VIN−) of the third ADC IC. If the analog signal related to the output voltage and the output current of the third charging battery is input to the third ADC IC, the third ADC IC converts the received analog signal into an 8-bit digital signal through terminals DB0˜DB7, such that the 8-bit digital signal is applied to the input terminal of the third non-inverting buffer unit.

The third non-inverting buffer unit 123d-4 performs non-inverting of the 8-bit digital signal, that is transmitted from the third ADC IC and relates to an output voltage and an output current of the third charging battery, so that the non-inverting result is output to the I/O ports (P0.0˜P0.7) of the microprocessor.

Through terminals 10E and 20E of the third non-inverting buffer unit, the 8-bit digital input signal (XRD0) related to an output voltage and an output current of the third charging battery is applied to an output terminal F0 of the board ID setup unit 123a.

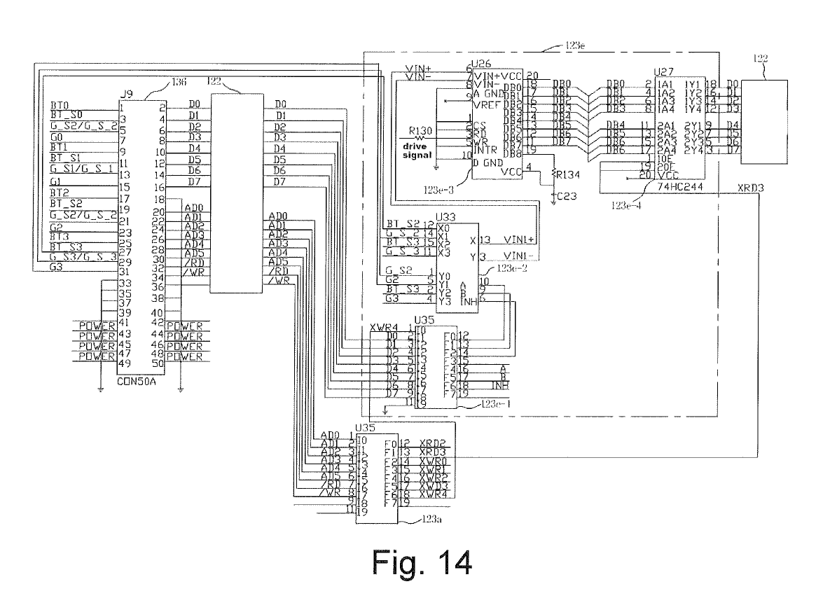

FIG. 14 is a circuit diagram illustrating one embodiment of a circuit in which a board ID setup unit and a first ADC from among constituent elements of the 4-terminal network control board are connected to each other. Referring to FIG. 14, if the 4-terminal network control board corresponding to a specific board ID is selected by an address setup signal of the microprocessor, the fourth ADC 123e controls a fourth charging battery corresponding to an address ‘11’ from among four charging batteries contained in one group matched with the 4-terminal network control board to be selected by a signal of 2 bits, is connected to positive (+) and negative (−) terminals of the fourth charging battery, and converts an analog signal related to an input voltage, an input current, an output voltage, and an output current of the fourth charging battery into a digital signal so as to transmit an 8-bit digital signal related to an input voltage, an input current, an output voltage, and an output current of the fourth charging battery to the microprocessor.

Referring still to FIG. 14, the fourth ADC 123e may include a fourth battery selection unit 123e-1, a fourth analog multiplexer 123e-2, a fourth ADC IC 123e-3, and a fourth non-inverting buffer 123e-4.

In the case of using the fourth battery selection unit 123e-1, in order for the charging battery unit to be selected according to the address value established in the microprocessor, if the 4-terminal network control board corresponding to a specific board ID of the 4-terminal network control board is selected, a fourth charging battery corresponding to an address ‘11’ from among four charging batteries belonging to one group matched with the 4-terminal network control board is selected by a signal of 2 bits.

In one embodiment, an output terminal F6 of the board ID setup unit 123a is connected to the input terminal 10, such that the 4-terminal network control board corresponding to a specific board ID is selected as a signal of 4 bits by the 4-bit operation. I/O ports (P0.0˜P0.7) of the microprocessor are connected to input terminals (I1˜I8), respectively, such that the 8-bit digital signal related to an input voltage, an input current, an output voltage, and an output current of the fourth charging battery from among four charging batteries belonging to one group matched with the 4-terminal network control board is input to the input terminals (I1˜I8).

A channel terminal A of the fourth analog multiplexer in one embodiment is connected to an output terminal F0, and a channel terminal B of a fourth analog multiplexer is connected to an output terminal F1, such that a fourth charging battery corresponding to the address ‘11’ is selected through the 2-bit operation.

The fourth analog multiplexer 123e-2 is connected to an input voltage detection terminal, an input current detection terminal, an output voltage detection terminal, and an output current detection terminal of the fourth charging battery. A specific analog signal related to an input voltage, an input current, an output voltage, and an output current from among several analog signals transmitted from the fourth charging battery is selected by the fourth analog multiplexer 123e-2, such that the detected signal is transmitted to the fourth ADC IC through two channels.

For example, the fourth analog multiplexer 123e-2 may detect an analog signal related to an output voltage and an output current, and transmits the detected signal to the fourth ADC through 2 channels. A detailed operation of the fourth analog multiplexer 123e-2 will hereinafter be described.

If the output terminal F0 of the fourth battery selection unit is connected to the channel terminal A, the output terminal F1 of the fourth battery selection unit is connected to the channel terminal B, and a fourth charging battery corresponding to the address ‘01’ is selected through the 2-bit operation, an output voltage that is loaded at positive (+) and negative (−) terminals of the fourth charging battery is applied to input terminals X0 and Y0 of the fourth analog multiplexer 123e-2, such that the fourth analog multiplexer 123e-2 transmits the received voltage signal to a terminal (VIN+) of the fourth ADC IC through an output terminal (X), and transmits the received voltage signal to a terminal (VIN−) of the fourth ADC IC through the output terminal (Y). An output current loaded at both terminals equal to the positive (+) and negative (−) terminals of the fourth charging battery is applied to the input terminals X1 and Y1, such that the output current is transmitted to a terminal (VIN+) of the fourth ADC IC through the output terminal (X) and is transmitted to a terminal (VIN−) of the fourth ADC IC through the output terminal (Y).

The fourth ADC IC 123e-3 receives an analog signal related to an output voltage and an output current of the fourth charging battery from the fourth analog multiplexer, converts an analog signal related to the output voltage and the output current of the fourth charging battery into an 8-bit digital signal, and transmits the 8-bit digital signal to the fourth non-inverting buffer unit.

In more detail, an output terminal (X) of the fourth analog multiplexer is connected to the terminal (VIN+) of the fourth ADC IC, and an output terminal (Y) of the fourth analog multiplexer is connected to a terminal (VIN−) of the fourth ADC IC. If the analog signal related to the output voltage and the output current of the fourth charging battery is input to the fourth ADC IC, the fourth ADC IC converts the received analog signal into an 8-bit digital signal through terminals DB0˜DB7, such that the 8-bit digital signal is applied to the input terminal of the fourth non-inverting buffer unit.

The fourth non-inverting buffer unit 123e-4 performs non-inverting of the 8-bit digital signal, that is transmitted from the fourth ADC IC and relates to an output voltage and an output current of the fourth charging battery, so that the non-inverting result is output to the I/O ports (P0.0˜P0.7) of the microprocessor.

Through terminals 10E and 20E of the fourth non-inverting buffer unit, the 8-bit digital input signal (XRD0) related to an output voltage and an output current of the fourth charging battery is applied to an output terminal F1 of the board ID setup unit 123a.

In this manner, one embodiment of the 4-terminal network control board 123 is disclosed as comprised of the board ID setup unit 123a, the first ADC 123b, the second ADC 123c, the third ADC 123d, and the fourth ADC 123e may be contained in each of the first 4-terminal network control board, the second 4-terminal network control board, the third 4-terminal network control board, the fourth 4-terminal network control board, the fifth 4-terminal network control board, the sixth 4-terminal network control board, the seventh 4-terminal network control board, and the eighth 4-terminal network control board.

Next, the 32-channel battery power-supply module 130 will hereinafter be described with reference to the drawings.

The 32-channel battery power-supply module 130 in one form is comprised of 32 charging battery cell structures. An input voltage detection terminal and an input current detection terminal of the 32-channel 4-terminal charging module 120 are connected to the positive (+) terminal of each charging battery. An output voltage detection terminal and an output current detection terminal of the 32-channel 4-terminal charging module 120 are connected to the negative (−) terminal of each charging battery. The 32-channel battery power-supply module 130 is quickly charged through the 32-channel 4-terminal network charging module 120. As shown in FIG. 5, the 32-channel battery power-supply module 130 may be comprised of a charging battery unit 131, an input voltage detection terminal 132, an input current detection terminal 133, an output voltage detection terminal 134, an output current detection terminal 135, and a connector 136 for connection to the charging battery unit.

The charging battery unit 131 in one form performs power control through the DC/DC converter in such a manner that the electricity generated from the solar panel or the commercial power source is increased by a predetermined voltage of 1V, and enters a standby mode through a collector terminal of the DAR transistor. The microprocessor compares a current charging voltage of the charging battery unit with a reference voltage of 4.2V. The microprocessor generates a turn-ON driving current of the DAR transistor only when the current charging voltage is equal to or less than a reference voltage of 4.2V, such that it charges the charging battery.

Referring to FIG. 8, the charging battery unit in one embodiment is configured in the form of a slim rectangular box, and a 4-pin type connection pin 131-1b is configured in a projected format so that the charging battery unit can be detachably connected to a connector for connection to the 4-pin type charging battery unit.

Referring to FIG. 7, the first-group charging battery unit may be comprised of a first charging battery 131-1, a second charging battery 131-2, a third charging battery 131-3, and a fourth charging battery 131-4. The second-group charging battery unit may be comprised of a fifth charging battery 131-5, a 6th charging battery 131-6, a 7th charging battery 131-7, and an 8th charging battery 131-8. The third-group charging battery unit may be comprised of a 9th charging battery 131-9, a 10th charging battery 131-10, an 11th charging battery 131-11, and a 12th charging battery 131-12. The fourth-group charging battery unit may be comprised of a 13th charging battery 131-13, a 14th charging battery 131-14, a 15th charging battery 131-15, and a 16th charging battery 131-16. The fifth-group charging battery unit may be comprised of a 17th charging battery 131-17, an 18th charging battery 131-18, a 19th charging battery 131-19, and a 20th charging battery 131-20. The sixth-group charging battery unit may be comprised of a 21st charging battery 131-21, an 22nd charging battery 131-22, a 23rd charging battery 131-23, and a 24th charging battery 131-24. The seventh-group charging battery unit may be comprised of a 25th charging battery 131-25, a 26th charging battery 131-26, a 27th charging battery 131-27, and a 28th charging battery 131-28. The eighth-group charging battery unit may be comprised of a 29th charging battery 131-29, a 30th charging battery 131-30, a 31st charging battery 131-31, and a 32nd charging battery 131-32.

The charging battery unit may be detachably connected to the connector formed on the first PCB.

If four constituent elements from among several constituent elements of the 32-channel battery power-supply module 130 configure one group, one 4-terminal network control board for detecting an input voltage, an input current, an output voltage, and an output current by directly controlling the four charging batteries is assigned to each group, such that the user can easily replace an old charging battery with a new one regardless of time or place.

In other words, a first 4-terminal network control board 123-1 may be detachably connected so as to detect an input voltage, an input current, an output voltage, and an output current by directly controlling the first-group charging battery unit comprised of first to fourth charging batteries 131-1 to 131-4. A second 4-terminal network control board 123-2 may be detachably connected so as to detect an input voltage, an input current, an output voltage, and an output current by directly controlling the second-group charging battery unit comprised of fifth to eighth charging batteries 131-5 to 131-8. A third 4-terminal network control board 123-3 may be detachably connected so as to detect an input voltage, an input current, an output voltage, and an output current by directly controlling the third-group charging battery unit comprised of ninth to 12th charging batteries 131-9 to 131-12. A fourth 4-terminal network control board 123-4 may be detachably connected so as to detect an input voltage, an input current, an output voltage, and an output current by directly controlling the fourth-group charging battery unit comprised of 13th to 16th charging batteries 131-13 to 131-16. A fifth 4-terminal network control board 123-5 may be detachably connected so as to detect an input voltage, an input current, an output voltage, and an output current by directly controlling the fifth-group charging battery unit comprised of 17th to 20th charging batteries 131-17 to 131-0. A sixth 4-terminal network control board 123-6 may be detachably connected so as to detect an input voltage, an input current, an output voltage, and an output current by directly controlling the sixth-group charging battery unit comprised of 21th to 24th charging batteries 131-21 to 131-24. A seventh 4-terminal network control board 123-7 may be detachably connected so as to detect an input voltage, an input current, an output voltage, and an output current by directly controlling the seventh-group charging battery unit comprised of 25th to 28th charging batteries 131-25 to 131-28.

An eighth 4-terminal network control board 123-8 may be detachably connected so as to detect an input voltage, an input current, an output voltage, and an output current by directly controlling the eighth-group charging battery unit comprised of 29th to 32nd charging batteries 131-29 to 131-32.

The input voltage detection terminal 132 detects an input voltage which is charged in the positive (+) terminal of the charging battery unit through the power control unit.

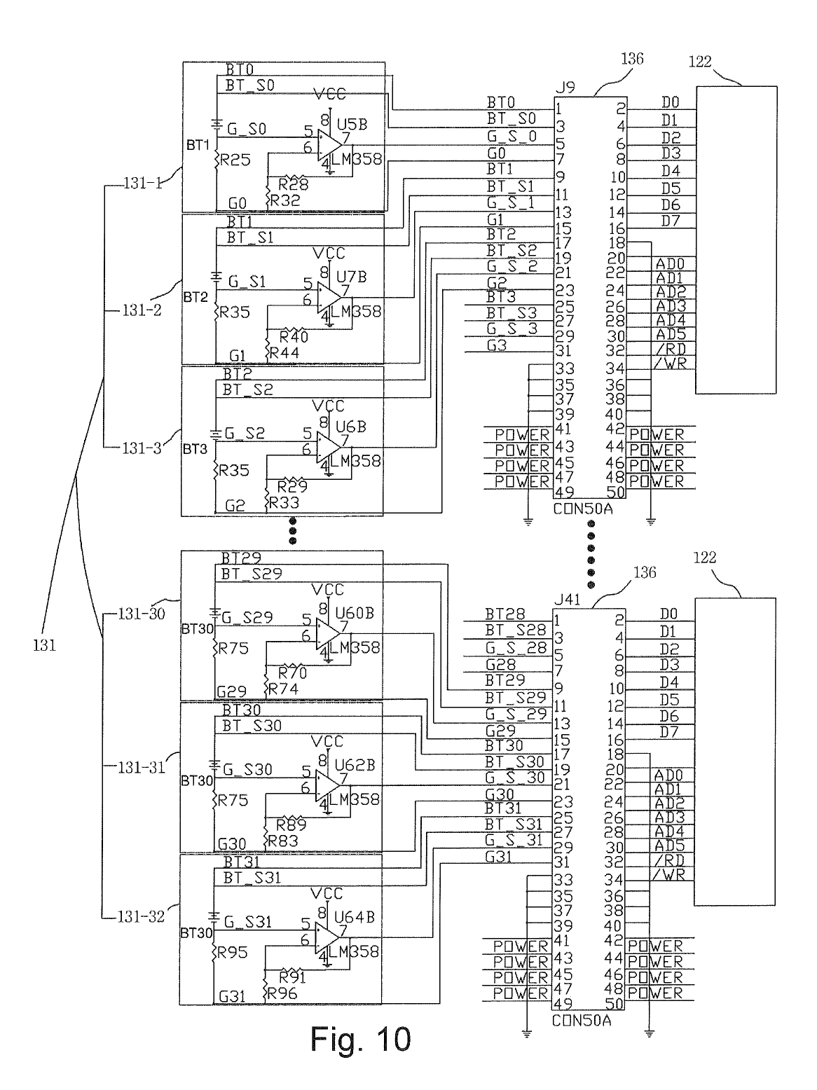

FIG. 10 is a circuit diagram illustrating one embodiment of a circuit in which a charging battery unit comprised of 32 battery cell structures is connected to a connector for connection to the charging battery unit. Referring to FIG. 10, a line (BT0) connected to the front end of the positive (+) terminal of the charging battery unit is set to an input voltage detection terminal.

The input current detection terminal 133 may detect an input current flowing into the negative (−) terminal of the charging battery unit through the power control unit.

Referring still to FIG. 10, the line GO that is connected to the resistor R25 through the front end of the negative (−) terminal of the charging battery unit is set to an input voltage detection terminal.

The output voltage detection terminal 134 of FIG. 5 may detect an output voltage loaded at positive (+) and negative (−) terminals of the charging battery unit.

Referring still to FIG. 10, a line (BT_SO) for detecting an output voltage across the positive (+) and negative (−) terminals of the charging battery unit is set to an output voltage detection terminal.

The output current detection terminal 135 of FIG. 5 may detect an output current across the positive (+) and negative (−) terminals of the charging battery unit.

Referring again to FIG. 10, a line (G_SO) for detecting an output current detected through the resistor R25 connected to the negative (−) terminal of the charging battery unit is set to an output current detection terminal.

The output current detection terminal in one form includes an output current amplifier that amplifies an output current of the charging battery unit through the output current detection terminal, and applies the amplified output current to the connector for connection to the 4-terminal network control board through the other connector for connection to the charging battery unit.

The connector for connection to the charging battery unit is connected one-to-one to an input voltage detection terminal, an input current detection terminal, an output voltage detection terminal, and an output current detection terminal of the charging battery unit, such that it is connected to the other connector for connection to the 4-terminal network control board.

The connector for connection to the charging battery unit is installed at one side of the rear end of the first PCB, and is connected one-to-one to an input voltage detection terminal, an input current detection terminal, an output voltage detection terminal, and an output current detection terminal of each of the 32 charging batteries, such that it is connected to the other connector for connection to the 4-terminal network control board.

The connector for connection to the charging battery unit is connected to each of the 8-bit digital signal input terminal and an address setup signal terminal of the microprocessor.

Next, the monitoring unit 200 will hereinafter be described with reference to the drawings.

The monitoring unit 200 in one embodiment is connected to an RS-232 connection port 202 of the battery pack apparatus. Therefore, the monitoring unit 200 receives a variety of signals from the microprocessor. These signals may be selected from the list of: a connection signal (POW_LED) for connecting a charging battery to a multi-channel battery, a full charge signal (FULL_CHARGE) of the charging battery, a charge input signal (CHARGE_LED) of the charging battery through the power control unit, a discharge signal (DISCHARGE_LED) of the charging battery, an overvoltage signal (OVER_VOLTAGE) of the charging battery, an overcurrent signal (OVER_CURRENT) of the charging battery, an overdischarge signal (OVER_DISCHARGE) of the charging battery, and a test input signal (TEST) of the charging battery are applied to the monitoring unit 200. The monitoring unit 200 displays a charging battery status of the 32-channel battery power-supply module, and is comprised of a notebook or desktop computer having a monitoring function.

The monitoring unit in one form monitors an input voltage, an input current, a charging battery, and a charging current of the charging battery. If a voltage of the charging battery is higher or lower than a reference voltage, an event is generated and transmitted to the microprocessor. In this case, under the control of the microprocessor, the charging battery is charged or discharged.

Next, the solar panel 300 will hereinafter be described with reference to the annexed drawings.

The solar panel 300 collects the solar energy, generates electricity, and provides the electricity to the power control unit. The solar panel 300 in one form is attached on the top surface of the PCB by a filler material formed of either PVB (Polyvinyl Butyral) having a small reduction of transmission rate or EVA (Ethylene Vinyl Acetate) having a superior excess moisture tolerance.

The solar panel in one form includes a plurality of first unit cells related to a positive (+) terminal and a plurality of second unit cells related to a negative (−) terminal. The first unit cells are spaced apart from the second unit cells, and the first unit cells and the second unit cells may be arranged in the form of a matrix. Individual unit cells may be connected in series to or in parallel to one another by an inter-connector formed of aluminum (Al) foil, so that a solar cell array is formed.

In this case, the number of solar cells connected in series may be determined according to the charging capacity of the charging battery.

The inter-connector for interconnecting individual unit cells is connected to a plated power-supply terminal located at one side of the PCB.

Transparent polycarbonate instead of a conventional glass substrate may be deposited on the solar cell array.

In this manner, the transparent polycarbonate layer is deposited on the solar cell array, solar electromagnetic radiation is reflected from the surface of the conventional glass substrate, such that the transparent polycarbonate layer can prevent solar energy loss.

A method for performing a 4-terminal network operation upon the control of the microprocessor, performing sampling using a reference value at a predetermined timing point, and charging the multi-channel battery power-supply module through multiple channels (i.e., a plurality of charging batteries) will hereinafter be described with reference to the drawings.

In this case, the multi-channel battery power-supply module may be set to a 32-channel battery power-supply module.

First, the term ‘4-terminal network’ is described in one form as follows. In the 4-terminal network, two input terminals 1 and 1′ making one pair and two output terminals 2 and 2′ making one pair are contained in a circuit network, such that the circuit network can be handled using only four terminals.

When the DC power source transformed by the power control unit is input to the 32-channel battery power-supply module, the battery pack apparatus in one form detects an input voltage and an input current, detects an output voltage and an output current generated from positive (+) and negative (−) terminals of the 32-channel battery power-supply module, and transmits the detected output voltage and the detected output current to the microprocessor. The battery pack apparatus performs operation processing under the control of the microprocessor, performs sampling using a reference value at a predetermined timing point, and quickly charges the 32-channel battery power-supply module through 32 channels (i.e., 32 charging batteries).

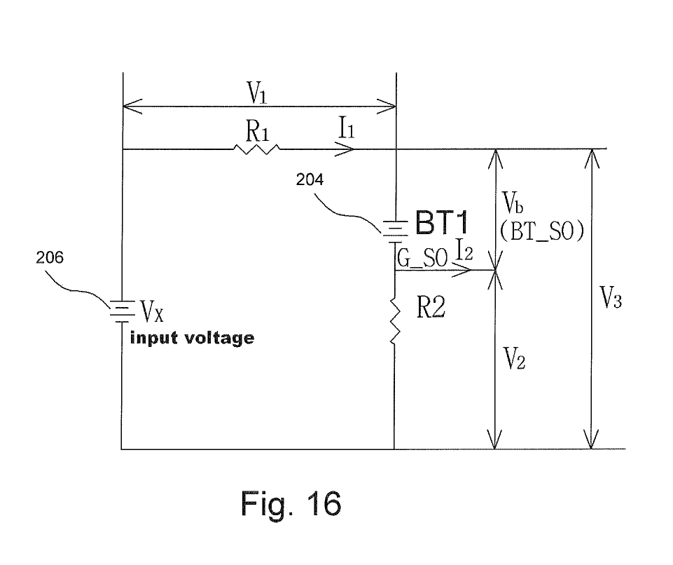

FIG. 16 is a basic circuit diagram of one embodiment of the 4-terminal network. In FIG. 16, R1 is indicative of a resistance generated from a connection line between the charger 206 charged with electricity generated from the solar panel and a first charging battery 204. R2 is indicative of a resistor in e one embodiment of 0.1Ω to measure a current signal flowing into the first charging battery. Vx is indicative of an input voltage. V1 is indicative of a voltage (=input voltage) generated at both ends of the resistor R1 according to the charging current of the first charging battery. I1 is indicative of an input current. V2 is indicative of a voltage generated at both ends of the resistor R2. Vb is indicative of a voltage (=output voltage) loaded at positive (+) and negative (−) terminals of the first charging battery. V3 is equal to V1+V2, as denoted by V3=V1+V2. I2 is indicative of a current (=output current) flowing into the first charging battery.

In this case, a voltage of V2 is measured so as to represent the current signal flowing into the first charging battery in the form of an equation.

In this case, the current I2 flowing into the first charging battery can be represented by the following equation 1.

$${I}_{2} = \frac{{V}_{2}}{{R}_{2}} \qquad [ Equation 1 ]$$

Subsequently, in order to represent the voltage (Vb) loaded at the positive (+) and negative (−) terminals of the first charging battery in the form of an equation, a voltage of V3 is measured.

In this case, the voltage (Vb) loaded at the positive (+) and negative (−) terminals of the first charging battery can be represented by the following equation 2.

Vb=V3−V2 [Equation 2]

Using Equations 1 and 2, the first charging battery is charged according to the 4-terminal network scheme on the basis of a rated current (=output current) and a rated voltage (=output voltage) of the first charging battery.

Through the above-mentioned steps, the microprocessor performs the 4-terminal network operation, performs sampling using a reference value (e.g., 4.2V of a lithium ion battery), and quickly charges the multi-channel battery power-supply module through multiple channels (e.g., 16 channels, 32 channels, 64 channels, or 128 channels) corresponding to multiple charging batteries.

As apparent from the above description, the battery pack apparatus in one embodiment achieves a uniform power-supply status through a 4-terminal network so that a correct voltage and a correct current are provided. The battery pack apparatus can control a multi-channel battery power-supply unit to be quickly charged with electricity, and can monitor, in real time, an output voltage and a consumed current of the multi-channel 4-terminal battery. As a result, the battery pack apparatus can effectively increase the charging efficiency of the multi-channel battery power-supply module in proportion to the number of multiple channels, as compared to the related art.

Although the present invention has been described in connection with specific preferred embodiments, those skilled in the art will appreciate that various modifications, additions, and substitutions to the specific elements are possible, without departing from the scope and spirit of the present invention as disclosed in the accompanying claims.

Therefore I claim:

1. A battery pack apparatus which uses electricity generated from a solar panel and a commercial power source and includes a multi-channel 4-terminal network charging module and a 32-channel battery power-supply module, the apparatus comprising:
a. a main frame;
b. a 32-channel 4-terminal charging unit which
i. is formed in the main frame,
ii. is connected to positive and negative connection terminals of a charging battery of a 32-channel battery power-supply module,
iii. reads an input voltage,
iv. an input current,
v. an output voltage, and an output current of the charging battery,
vi. performs detection and operation processing by a 4-terminal network, and
vii. charges a 32-channel battery power-supply unit using a 32-channel 4-terminal network scheme; and
c. a 32-channel battery power-supply unit including 32 charging battery cell structures, in which an input voltage detection terminal and an input current detection terminal of the 32-channel 4-terminal charging unit are connected to a positive terminal of each charging battery, and an output voltage detection terminal and an output current detection terminal of the 32-channel 4-terminal charging unit are connected to a negative terminal of each charging battery.

2. The apparatus according to claim 1, wherein the 32-channel 4-terminal charging unit comprises:
a. a power control unit which performs a power control function in such a manner that electricity generated from the solar panel and the commercial power source are converted according to capacity of a charging battery unit, and the converted electricity and commercial power source are provided;
b. a microprocessor which receives a power signal controlled by the power control unit, transmits a wake-up driving signal to each device, reads an input voltage, an input current, an output voltage, an output current of each charging battery unit through a 4-terminal network control board, performs detection and operation processing using a 4-terminal network, performs sampling at a specific timing point where the 32-channel battery power-supply unit is charged according to a 32-channel 4-terminal network scheme, controls the 32-channel battery power-supply unit to be sequentially charged through 32 channels, and controls a monitoring unit to display a status of the charging battery unit and a status of the 32-channel power-supply unit; and
c. a 4-terminal network control board which is detachably inserted into one group of charging battery units equal to four battery units, from among constituent elements of the 32-channel battery power-supply module, and is connected to the positive and negative terminals of each charging battery unit, reads an input voltage, an input current, an output voltage, and an output current of the charging battery unit, converts an analog signal into a digital signal, such that an 8-bit digital signal related to the input voltage, the input current, the output voltage, and the output current of the charging battery unit are applied to the microprocessor.

3. The apparatus according to claim 2, wherein the power control unit controls the electricity or the commercial power source to be higher than capacity of the charging battery unit by a predetermined voltage of 1V through resistors, applies the resultant electricity or commercial power source to a specific terminal of a DC/DC converter,
a. wherein, if the electricity generated from the solar panel or the commercial source is voltage-division processed through resistors, and the voltage-division result is applied to a terminal of the DC/DC converter and a current peak sense terminal, a comparator compares a first voltage applied to a comparison inverting input terminal of the DC/DC converter with an internal reference voltage,
b. if the first voltage is higher than the reference voltage, a drive collector terminal is driven so that a transistor is turned on through a sensing resistor, a voltage-divided resultant voltage applied to a collector terminal of the transistor and the commercial power source pass through an emitter terminal, are smoothed through a diode, and are finally output through an inductor, whereby the output voltage of the inductor is applied to a collector terminal of a DAR tr4ansistor and therefore a standby mode is provided,
c. if the microprocessor transmits an 8-bit digital signal indicating a current charging voltage status of a charging battery unit to the buffer unit, the buffer unit transmits the received signal to the first Digital-to-Analog Converter (DAC), and the first DAC compares a current charging voltage with a reference voltage, and
d. if the current charging voltage is equal to or less than the reference voltage, a turn-ON driving current signal of the DAR transistor flows into a positive terminal of an amplifier connected to an output terminal,
e. whereby, if the turn-ON driving current signal of the DAR transistor is applied, a charging voltage applied to the collector terminal of the DAR transistor passes through an emitter terminal and is charged in the charging battery unit.

4. The apparatus according to claim 2, wherein, in the microprocessor 122, the monitoring unit is connected to input/output (I/O) ports (P1.0˜P1.7) through an RS-232 cable, such that a connection signal for connecting a charging battery to a multi-channel battery, a full charge signal of the charging battery, a charge input signal of the charging battery through the power control unit, a discharge signal of the charging battery, an over-voltage signal of the charging battery, an over-current signal of the charging battery, an over-discharge signal of the charging battery, and a test input signal of the charging battery are output to the monitoring unit,
a. wherein the I/O ports (P0.0˜P0.7) are set to 8-bit digital signal input terminals, respectively, and are connected to a first ADC, a second ADC, a third ADC, and a fourth ADC,
b. the 8-bit digital signal related to an input voltage, an input current, an output voltage, and an output current of the charging battery are input to each of the first to fourth ADCs to, and
c. a board Identifier (ID) setup unit is connected to I/O ports (P2.0˜P2.5), and controls four charging batteries contained in one group to be selected by a read command signal and a write command signal, wherein one group comprised of four charging batteries belongs to the 4-terminal network control board corresponding to an identifier (ID) that is established according to 6-bit address values.

5. The apparatus according to claim 2, wherein the 4-terminal network control board comprises:
a. a board Identifier (ID) setup unit which is connected to an address setup terminal of the microprocessor, establishes a specific board ID in the 4-terminal network control board in such a manner that a desired charging battery unit is selected according to an established address value, controls each group charging battery unit comprised of four charging batteries matched with the 4-terminal network control board corresponding to a specific board ID to be selected according to a read command signal RD and a write command signal WD of the microprocessor;
b. a first Analog-to-Digital Converter (ADC), in order for the charging battery unit to be selected according to the address value established in the microprocessor, if the 4-terminal network control board corresponding to a specific board ID of the 4-terminal network control board is selected, for controlling a first charging battery corresponding to an address ‘00’ from among four charging batteries belonging to one group matched with the 4-terminal network control board to be selected by a signal of 2 bits, being connected to positive and negative terminals of the first charging battery, converting an analog signal related to an input voltage, an input current, an output voltage, and an output current of the first charging battery into a digital signal, and thus transmitting an 8-bit digital signal related to an input voltage, an input current, an output voltage, and an output current of the first charging battery to the microprocessor;
c. a second ADC, if the 4-terminal network control board corresponding to a specific board ID is selected by an address setup signal of the microprocessor, for controlling a second charging battery corresponding to an address ‘01’ from among four charging batteries contained in one group matched with the 4-terminal network control board to be selected by a signal of 2 bits, being connected to positive and negative terminals of a second charging battery, converting an analog signal related to an input voltage, an input current, an output voltage, and an output current of the second charging battery into a digital signal, and thus transmitting an 8-bit digital signal related to an input voltage, an input current, an output voltage, and an output current of the second charging battery to the microprocessor;
d. a third ADC, if the 4-terminal network control board corresponding to a specific board ID is selected by an address setup signal of the microprocessor, for controlling a third charging battery corresponding to an address ‘10’ from among four charging batteries contained in one group matched with the 4-terminal network control board to be selected by a signal of 2 bits, being connected to positive and negative terminals of the third charging battery, converting an analog signal related to an input voltage, an input current, an output voltage, and an output current of the third charging battery into a digital signal, and thus transmitting an 8-bit digital signal related to an input voltage, an input current, an output voltage, and an output current of the third charging battery to the microprocessor; and
e. a fourth ADC, if the 4-terminal network control board corresponding to a specific board ID is selected by an address setup signal of the microprocessor, for controlling a fourth charging battery corresponding to an address ‘11’ from among four charging batteries contained in one group matched with the 4-terminal network control board to be selected by a signal of 2 bits, being connected to positive and negative terminals of the fourth charging battery, converting an analog signal related to an input voltage, an input current, an output voltage, and an output current of the fourth charging battery into a digital signal, and thus transmitting an 8-bit digital signal related to an input voltage, an input current, an output voltage, and an output current of the fourth charging battery to the microprocessor.

6. The apparatus according to claim 1, wherein the 32-channel battery power-supply module comprises:
a. a charging battery unit comprising:
i. a first-group charging battery unit,
ii. a second-group charging battery unit,
iii. a third-group charging battery unit,
iv. a fourth-group charging battery unit,
v. a fifth-group charging battery unit,
vi. a sixth-group charging battery unit,
vii. a seventh-group charging battery unit, and
viii. an eighth-group charging battery unit,
b. wherein the first-group charging battery unit comprises:
i. a first charging battery,
ii. a second charging battery,
iii. a third charging battery, and a
iv. fourth charging battery,
c. wherein the second-group charging battery unit comprises:
i. a fifth charging battery,
ii. a 6th charging battery,
iii. a 7th charging battery, and
iv. an 8th charging battery,
d. wherein the third-group charging battery unit comprises:
i. a 9th charging battery,
ii. a 10th charging battery,
iii. an 11th charging battery, and
iv. a 12th charging battery,
e. wherein the fourth-group charging battery unit comprises:
i. a 13th charging battery,
ii. a 14th charging battery,
iii. a 15th charging battery, and
iv. a 16th charging battery,
f. wherein the fifth-group charging battery unit comprises:
i. a 17th charging battery,
ii. an 18th charging battery,
iii. a 19th charging battery, and
iv. a 20th charging battery,
g. wherein the sixth-group charging battery unit comprises:
i. a 21st charging battery,
ii. an 22nd charging battery,
iii. a 23rd charging battery, and
iv. a 24th charging battery,
h. wherein the seventh-group charging battery unit comprises:
i. a 25th charging battery,
ii. a 26th charging battery,
iii. a 27th charging battery, and
iv. a 28th charging battery, and
i. wherein the eighth-group charging battery unit comprises:
i. a 29th charging battery,
ii. a 30th charging battery,
iii. a 31st charging battery, and
iv. a 32nd charging battery;
j. an input voltage detection terminal for detecting an input voltage applied to a positive terminal of a charging battery unit through a power control unit;
k. an input current detection terminal for detecting an input current flowing into a negative terminal of the charging battery unit through the power control unit;
l. an output voltage detection terminal for detecting an output voltage loaded at positive and negative terminals of the charging battery unit;
m. an output current detection terminal for detecting an output current loaded at positive and negative terminals of the charging battery unit; and
n. a connector for connection to the charging battery unit, which is connected one-to-one to the input voltage detection terminal, the input current detection terminal, the output voltage detection terminal, and the output current detection terminal of the charging battery unit so as to be connected to another connector for connection to a 4-terminal network control board.

7. The apparatus according to claim 6, wherein the charging battery unit installs a 4-pin type connection pin configured in a projected format at its own lower end, so that the charging battery unit is detachably connected to a connector for connection to the charging battery unit of a first Printed Circuit Board (PCB).

8. The apparatus according to claim 6, wherein the output current detection terminal includes:
a. an output current amplifier which amplifies the charging battery unit's output current detected through the output current detection terminal, and applies the amplified output current to the connector for connection to the 4-terminal network control board through the connector for connection to the charging battery unit.

9. The apparatus according to claim 1, wherein the battery pack apparatus allows a single 4-terminal network control board to be detachably inserted at intervals of four charging batteries belonging to one group, wherein the single 4-terminal network control board detects an input voltage, an input current, an output voltage, and an output current by directly controlling the four charging batteries of one group.

10. A battery pack apparatus for an electric hybrid vehicle, the apparatus comprising:
a. a main frame;
b. an n-channel k-terminal charging unit which
i. is formed in the main frame,
ii. is connected to positive and negative connection terminals of a charging battery of a n-channel battery power-supply module,
iii. reads an input voltage,
iv. reads an input current,
v. reads an output voltage,
vi. reads an output current of the charging battery,
vii. performs detection and operation processing by a k-terminal network, and
viii. charges a n-channel battery power-supply unit using a n-channel k-terminal network scheme;
c. a n-channel battery power-supply unit including n charging battery cell structures, in which an input voltage detection terminal and an input current detection terminal of the n-channel k-terminal charging unit are connected to a positive terminal of each charging battery, and an output voltage detection terminal and an output current detection terminal of the n-channel k-terminal charging unit are connected to a negative (−) terminal of each charging battery, such that the n-channel battery power-supply unit is quickly charged through the n-channel 4-terminal network charging unit.
